(19) United States
(12) Patent Application Publication
(10) Pub. No.: US 2024/0397204 A1
(43) Pub. Date: Nov. 28, 2024

(54) IMAGING DEVICE, CONTROL METHOD, AND PROGRAM

(71) Applicant: SONY GROUP CORPORATION, TOKYO (JP)

(72) Inventor: SEIICHI INOMATA, TOKYO (JP)

(21) Appl. No.: 18/693,631

(22) PCT Filed: Aug. 16, 2022
(86) PCT No.: PCT/JP2022/030942

§ 371 Date: Mar. 20, 2024

(30) Foreign Application Priority Data
Oct. 4, 2021 (JP) 2021-163336

(51) Int. Cl. H04N 23/67; G03B 13/36; G06T 7/20; G06T 7/50; H04N 23/61

(52) U.S. Cl. CPC H04N 23/675; G03B 13/36; G06T 7/20; G06T 7/50; H04N 23/61

(57) ABSTRACT

An imaging device includes a focus control unit that performs trigger detection in a manual focus state in which focus lens driving based on a manual operation is performed, and starts tracking autofocus processing on the basis of the detection of the trigger.

### TECHNICAL FIELD

The present technology relates to an imaging device, a method of controlling an imaging device, and a program, and particularly relates to a focus control technology.

### BACKGROUND ART

For example, as described in Patent Document 1, there is an imaging device in which an autofocus function (hereinafter, autofocus may be referred to as “AF”) is prepared as automatic focus control, and a manual focus function (hereinafter, manual focus may be referred to as “MF”) by manual operation is prepared.

### CITATION LIST

### Patent Document

Patent Document 1: Japanese Patent Application Laid-Open No. 2008-262049

### SUMMARY OF THE INVENTION

### Problems to be Solved by the Invention

In such an imaging device, it is desirable to perform appropriate focus control by linking AF control and MF operation according to various imaging opportunities of the user. For example, it is desirable to enable tracking AF to be executed on an appropriate target from a state in which a focusing operation is being performed in MF by a user operation (hereinafter also referred to as MF state) without a complicated operation.

In view of the foregoing, the present disclosure proposes a technology for easily achieving tracking AF according to a user's intention from an MF state.

### Solutions to Problems

An imaging device according to the present technology includes a control unit that performs trigger detection including processing of detecting a trigger in a manual focus state in which focus lens driving based on a manual operation is performed, and starts tracking autofocus processing on the basis of a result of the trigger detection.

Tracking autofocus is activated in response to detecting a predetermined trigger in the manual focus state.

### BRIEF DESCRIPTION OF DRAWINGS

FIG. 1 is a perspective view of an imaging device of an embodiment of the present technology.

FIG. 2 is a rear view of the imaging device of the embodiment.

FIG. 3 is a block diagram of the imaging device of the embodiment.

FIG. 4 is an explanatory diagram of a functional configuration example of the imaging device of the embodiment.

FIG. 5 is a flowchart of processing of a first embodiment.

FIG. 6 is an explanatory diagram of detection of defocus information or distance information of the embodiment.

FIG. 7 is an explanatory diagram of operation state transition according to the first embodiment.

FIG. 8 is an explanatory diagram of mode setting of the first embodiment.

FIG. 9 is an explanatory diagram of setting of a touch operation of the first embodiment.

FIG. 10 is a flowchart of processing of a second embodiment.

FIG. 11 is an explanatory diagram of operation state transition according to the second embodiment.

FIG. 12 is an explanatory diagram of a key assignment of the second embodiment.

FIG. 13 is a flowchart of processing of a third embodiment.

FIG. 14 is an explanatory diagram of operation state transition according to the third embodiment.

FIG. 15 is an explanatory diagram of object detection by semantic segmentation.

FIG. 16 is a flowchart of processing of a fourth embodiment.

FIG. 17 is an explanatory diagram of operation state transition according to the fourth embodiment.

FIG. 18 is an explanatory diagram of a color map in the fourth embodiment.

FIG. 19 is a flowchart of processing of a fifth embodiment.

FIG. 20 is an explanatory diagram of operation state transition according to the fifth embodiment.

### MODE FOR CARRYING OUT THE INVENTION

Hereinafter, embodiments will be described in the following order.
<1. Configuration of imaging device>
<2. Functional configuration of imaging device>
3. First Embodiment
4. Second Embodiment
5. Third Embodiment
6. Fourth Embodiment
7. Fifth Embodiment
<8. Summary and modification>

An explanation will be given on several phrases used in the present disclosure.

“Image” is used as a term including a moving image and a still image. It is assumed that not only the meaning as an image to be displayed but also the meaning as image data is included.

“Imaging” refers to generating image data on the basis of photoelectric conversion of an image sensor.

“Captured image” is a captured image obtained through photoelectric conversion of the image sensor, and includes an image recorded as a moving image or a still image, and an image displayed on the monitor as a through image or the like. “Subject” refers to all subjects included in a captured image.

“Object detection processing” is a generic term for processing of detecting a type of a specific subject in an image.

“Detection object” is an object detected by object detection processing among subjects. For example, the term refers to an image detected as a face, a person, a pupil, an animal, or a specific object among subjects, or a detected subject itself. “Tracking autofocus (tracking AF)” is a focus operation for automatically tracking a target subject.

### <1. Configuration of Imaging Device>

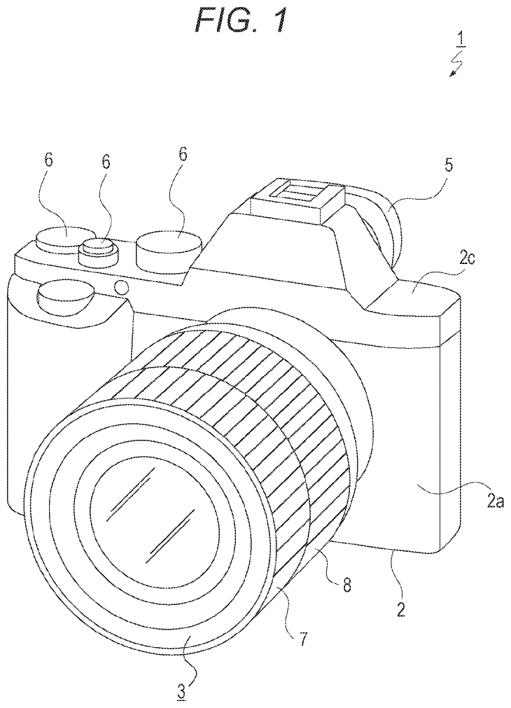

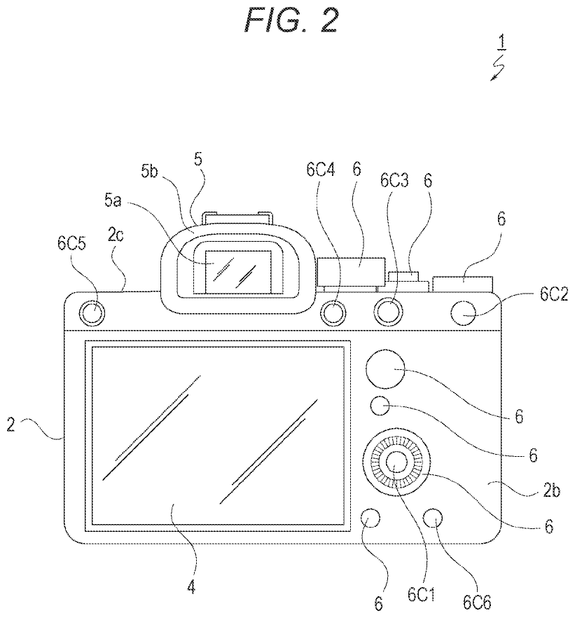

An appearance of an imaging device 1 according to the present embodiment is illustrated in FIGS. 1 and 2.

Note that the imaging device 1 is an example of a camera including an interchangeable lens, but is not limited thereto, and may be a lens-integrated camera. Furthermore, the technology of the present disclosure can be widely applied to various imaging devices incorporated in a still camera, a video camera, and other devices.

The imaging device 1 includes a camera housing 2 in which necessary units are disposed inside and outside, and a lens barrel 3 attached to a front surface portion 2a of the camera housing 2.

A rear monitor 4 is disposed on a rear surface portion 2b of the camera housing 2. A through image, a recorded image, and the like are displayed on the rear monitor 4.

The rear monitor 4 is, for example, a display device such as a liquid crystal display (LCD), an organic electro-luminescence (EL) display, or the like.

An electric view finder (EVF) 5 is disposed on an upper surface portion 2c of the camera housing 2. The EVF 5 includes an EVF monitor 5a and a frame-shaped enclosing portion 5b projecting backward so as to surround upper and left and right sides of the EVF monitor 5a.

The EVF monitor 5a is formed using an LCD, an organic EL display, or the like. Note that instead of the EVF monitor 5a, an optical view finder (OVF) may be provided.

Various operation elements 6 are provided on the rear surface portion 2b and the upper surface portion 2c. The operation elements 6 include elements in various modes such as a button, a dial, and a pressable and rotatable composite operation element. With these operation elements 6, for example, a shutter operation, a menu operation, a reproduction operation, a mode selection/switching operation, a focus operation, a zoom operation, and selection/setting of parameters such as a shutter speed and an F-number can be performed.

Here, custom keys 6C1, 6C2, 6C3, 6C4, 6C5, and 6C6 are illustrated as the operation elements 6. These are operation elements that function as so-called assignable buttons, and are, for example, buttons to which a predetermined operation function is initially allocated but to which a user can allocate an arbitrary operation function regardless.

For example, the custom key 6C4 or the like can be assigned as a button for a trigger operation for tracking AF to be described later.

Various lenses are disposed inside the lens barrel 3, and a ring-shaped focus ring 7 and a ring-shaped zoom ring 8 are included.

The focus ring 7 is rotatable in a circumferential direction, and a focus position can be moved in an optical axis direction by various lenses moving in the optical axis direction according to a rotation direction.

The “focus position” is an in-focus position of the imaging device 1 in the optical axis direction. This is, for example, the position of the subject with respect to the imaging device 1 in a case where there is a subject in focus. The focus position is changed by focus control.

By rotating the focus ring 7, the focus position on the imaging device 1 can be made closer or farther. Furthermore, by rotating the focus ring 7, manual focus control for manually adjusting an in-focus state can be achieved.

The zoom ring 8 is rotatable in the circumferential direction, and manual zooming control can be performed by the various lenses moving in the optical axis direction according to the rotation direction.

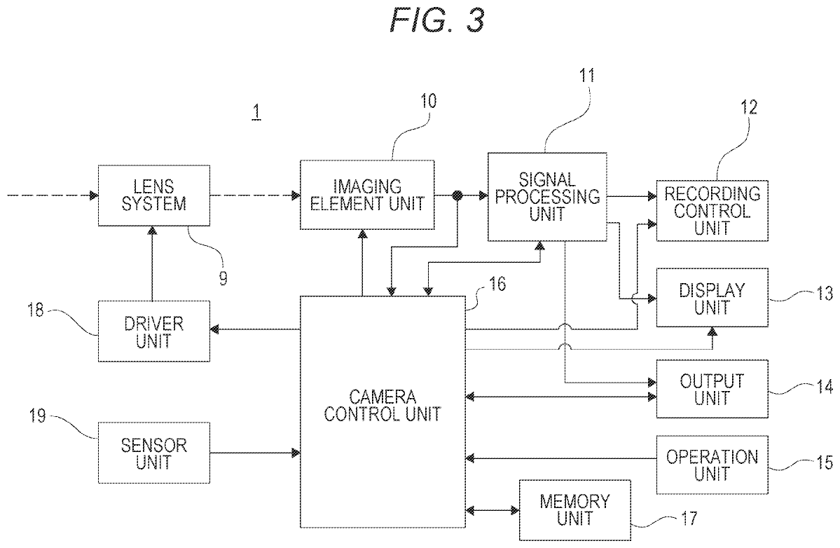

FIG. 3 is a block diagram of the imaging device 1. Note that in this drawing, the camera housing 2 and the lens barrel 3 are not particularly distinguished from each other.

Inside and outside the camera housing 2 and the lens barrel 3 of the imaging device 1, a lens system 9, an imaging element unit 10, a signal processing unit 11, a recording control unit 12, a display unit 13, an output unit 14, an operation unit 15, a camera control unit 16, a memory unit 17, a driver unit 18, a sensor unit 19, and the like are provided. In addition, a power supply unit and the like are appropriately provided.

The lens system 9 includes various lenses such as an incident end lens, a zoom lens, a focus lens, and a condenser lens, and a diaphragm mechanism that performs exposure control by adjusting, for example, an aperture amount of a lens or an iris (diaphragm) such that sensing is performed in a state where signal charges are not saturated and are within a dynamic range. A shutter unit such as a focal plane shutter may be provided. Note that a part of the optical system components such as the lens system 9 may be provided in the camera housing 2.

The imaging element unit 10 includes, for example, a charge coupled device (CCD) type or complementary metal-oxide semiconductor (CMOS) type image sensor, and a signal processing circuit for a photoelectrically converted signal. An image sensor having two-dimensionally arranged sensing elements photoelectrically converts light from a subject incident through the lens system 9. Then, the signal processing circuit performs, for example, correlated double sampling (CDS) processing, automatic gain control (AGC) processing, and analog/digital (A/D) conversion processing on an electric signal obtained by photoelectric conversion. The imaging element unit 10 outputs a captured image signal as digital data obtained by these processing to the signal processing unit 11 and the camera control unit 16.

The signal processing unit 11 includes, for example, a microprocessor specialized in digital signal processing such as a digital signal processor (DSP), a microcomputer, or the like.

The signal processing unit 11 performs various types of signal processing on the digital signal (captured image signal) transmitted from the imaging element unit 10.

Specifically, processing such as correction processing between R, G, and B color channels, white balance correction, aberration correction, and shading correction is performed.

Furthermore, the signal processing unit 11 performs YC generation processing of generating (separating) a luminance (Y) signal and a color (C) signal from R, G, and B image data, processing of adjusting luminance and color, and processing such as knee correction and gamma correction.

Moreover, the signal processing unit 11 performs conversion into a final output format by performing resolution conversion processing, codec processing for performing encoding for recording or communication, and the like. Image data converted into the final output format is stored in the memory unit 17. Furthermore, by outputting the image data to the display unit 13, an image is displayed on the rear monitor 4 or the EVF monitor 5a. Moreover, by outputting from an external output terminal, the image data is displayed on a device such as a monitor provided outside the imaging device 1.

The recording control unit 12 performs processing of storing image files (content files) such as still image data and moving image data, attribute information of the image files, thumbnail images, and the like in a recording medium including a nonvolatile memory, for example.

Various actual forms of the recording control unit 12 can be considered. For example, the recording control unit 12 may perform recording processing on a flash memory built in the imaging device 1, or may include a memory card (for example, a portable flash memory) that can be attached to and detached from the imaging device 1 and an access unit that accesses the memory card for storage and reading. Furthermore, the recording control unit 12 may be implemented as a hard disk drive (HDD) or the like as a form built in the imaging device 1.

The display unit 13 executes processing for performing various displays for an imaging person. The display unit 13 is, for example, the rear monitor 4 or the EVF monitor 5a. The display unit 13 performs processing of displaying the image data converted into an appropriate resolution input from the signal processing unit 11. As a result, a monitor image during moving image recording, a so-called through image which is a captured image during standby until moving image recording is started or shutter operation, or the like is displayed.

Moreover, the display unit 13 achieves display of various operation menus, icons, messages, and the like as a graphical user interface (GUI) on the screen on the basis of an instruction from the camera control unit 16.

Furthermore, the display unit 13 can display a reproduced image of the image data read from a recording medium in the recording control unit 12.

Note that in the present example, both the EVF monitor 5a and the rear monitor 4 are provided, but the invention is not limited to such a configuration, and it is also conceivable to provide only one of the EVF monitor 5a or the rear monitor 4, or one or both of the EVF monitor 5a and the rear monitor 4 may be configured to be detachable.

The output unit 14 performs data communication and network communication with an external device in a wired or wireless manner. For example, captured image data (a still image file or a moving image file) is transmitted to an external display device, recording device, reproduction device, or the like.

Furthermore, the output unit 14 may function as a network communication unit. For example, communication may be performed by various networks such as the Internet, a home network, and a local area network (LAN), and various data may be transmitted and received to and from a server, a terminal, or the like on the network.

The operation unit 15 includes not only the above-described various operation elements 6 (including the custom key 6C1 and the like), but also the rear monitor 4 adopting a touch panel system and the like, and outputs operation information corresponding to various operations such as a tap operation and a swipe operation of the user (imaging person and the like) to the camera control unit 16.

Note that the operation unit 15 may function as a reception unit of an external operation device such as a remote controller separate from the imaging device 1. Examples of the external operation device include a smartphone, a tablet, a Bluetooth (registered trademark) remote controller, a wired remote controller, a wireless operation device for focus operation, and the like.

The focus ring 7 that detects an operation for manual focus control and the zoom ring 8 that detects an operation for zooming control are one aspect of the operation unit 15.

The camera control unit 16 includes a microcomputer (arithmetic processing device) including a central processing unit (CPU), and performs overall control of the imaging device 1. Note that the control function described as the camera control unit 16 in FIG. 3 is actually implemented by separate microcomputers mounted on the camera housing 2 side and the lens barrel 3 side in some cases.

The camera control unit 16 performs, for example, recording control of a moving image or a still image according to a user operation, control of a shutter speed, a gain, a diaphragm, or the like, focus control, zoom control, an instruction regarding various types of signal processing in the signal processing unit 11, reproduction operation control of a recorded image file, and the like.

The camera control unit 16 also switches various image capturing modes and the like. Examples of the various image capturing modes include a still image capturing mode, a moving image capturing mode, a continuous image capturing mode for continuously acquiring still images, and the like.

The camera control unit 16 performs user interface control for enabling the user to operate these functions. The user interface (UI) control performs processing of detecting an operation with respect to each operation element 6 provided in the imaging device 1, display processing and operation detection processing with respect to the rear monitor 4, and the like.

Furthermore, the camera control unit 16 instructs the driver unit 18 to control various lenses included in the lens system 9.

For example, processing of designating an aperture value in order to secure a light amount necessary for AF control, an operation instruction of an aperture mechanism according to the aperture value, and the like are performed.

The memory unit 17 stores information and the like used for processing executed by the camera control unit 16. For example, the illustrated memory unit 17 comprehensively represents a read only memory (ROM), a random access memory (RAM), a flash memory, and the like.

The memory unit 17 may be a memory area built in a microcomputer chip as the camera control unit 16 or may be formed using a separate memory chip.

Programs and the like used by the camera control unit 16 are stored in the ROM, the flash memory, and the like of the memory unit 17. The ROM, the flash memory, and the like store an operating system (OS) for the CPU to control each unit, content files such as image files, and application programs, firmware, and the like for various operations.

The camera control unit 16 executes the program to control the entire imaging device 1 including the lens barrel 3.

The RAM of the memory unit 17 is used as a work area of the camera control unit 16 by temporarily storing data, programs, and the like used in various data processing executed by the CPU of the camera control unit 16.

The driver unit 18 is provided with, for example, a motor driver for a zoom lens drive motor, a motor driver for a focus lens drive motor, a diaphragm mechanism driver for a motor that drives a diaphragm mechanism, and the like.

Each driver supplies a drive current to a corresponding drive motor according to an instruction from the camera control unit 16.

The sensor unit 19 comprehensively represents various sensors mounted on the imaging device 1. As the sensor unit 19, for example, a position information sensor, an illuminance sensor, an acceleration sensor, and the like are mounted.

A sensor provided in the focus ring 7 or the zoom ring 8 to detect a rotation direction or an operation amount of the focus ring 7 or the zoom ring 8 is one aspect of the sensor unit 19.

Furthermore, for example, an inertial measurement unit (IMU) is mounted as the sensor unit 19, and the angular velocity may be detected by, for example, an angular velocity (gyro) sensor of three axes of pitch, yaw, and roll.

In addition, a distance measuring sensor such as a time of flight (ToF) sensor may be provided as the sensor unit 19. Distance information obtained by the distance measuring sensor is information of the depth to the subject. For example, the camera control unit 16 can generate a depth map corresponding to each frame of the captured image or detect depth information of a specific subject on the basis of the detection value of the distance measuring sensor.

Note that the camera control unit 16 can also obtain defocus information of the subject instead of or together with the distance. For example, defocus information is obtained by a phase difference signal obtained from an output of an image plane phase difference pixel provided in an image sensor of the imaging element unit 10. Since defocus information corresponds to a distance difference from a position in focus in focus control, defocus information can be treated equivalent to depth information. For example, the camera control unit 16 can generate a defocus map on the basis of a signal from the image plane phase difference pixel, convert the defocus map into a depth map, and detect depth information of a specific subject from defocus information of the subject.

In the present disclosure, the meaning of “depth information” includes defocus information and distance information.

### <2. Functional Configuration of Imaging Device>

The camera control unit 16 includes various functions by executing a program stored in the memory unit 17.

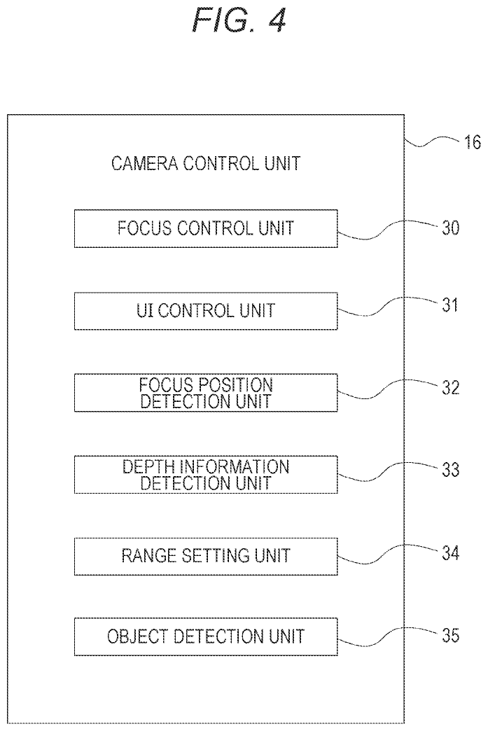

Each function of the camera control unit 16 will be described with reference to FIG. 4. Note that a part of each function may be included in the signal processing unit 11. Furthermore, a part of each function may be implemented by cooperation of the camera control unit 16 and the signal processing unit 11.

The camera control unit 16 includes, as functions related to processing of the present embodiment, functions as a focus control unit 30, a UI control unit 31, a focus position detection unit 32, a depth information detection unit 33, a range setting unit 34, and an object detection unit 35.

The focus control unit 30 is a function of mainly executing AF control. For example, AF control is performed using defocus information based on a signal from the above-described image plane phase difference pixel. For example, in an AF mode, lens drive control is performed so as to focus on the subject in the focus control target area in the plane of the captured image. For example, AF control is performed on a subject at the center of the screen.

Furthermore, in tracking AF, lens drive control for keeping focusing on the focus control target is performed according to movement of the focus control target (particularly, movement in the optical axis direction).

In the case of the present embodiment, the focus control unit 30 performs trigger detection in an MF state in which focus lens driving based on manual operation is performed, and performs processing of starting tracking AF processing on the basis of a trigger detection.

The UI control unit 31 is a function corresponding to an output to the user or an input from the user.

For example, the UI control unit 31 causes the display unit 13 to execute predetermined GUI display, and performs processing of presenting various types of information to the user and providing an operation. For example, icon display for menu display or state display is executed.

The UI control unit 31 performs processing of detecting a user operation on the operation unit 15. Specifically, processing of detecting an operation of the operation element 6, processing of detecting a touch operation on the rear monitor 4, and detecting an operation of rotating the focus ring 7, processing of detecting an operation of rotating the zoom ring 8, and the like are performed.

Note that the UI control unit 31 may detect an operation by an external operation device.

For example, in a case where the operation unit 15 receives an operation signal from an external operation device such as a smartphone, a tablet, a wireless remote controller, a wired remote controller, or a wireless operation device for focus operation, the UI control unit 31 detects these operations.

The focus position detection unit 32 detects a focus position that is variable by an MF operation. For example, the current focus position in MF is sequentially detected by a rotation amount of the focus ring 7, information of a position sensor of the focus lens, and the like. As a result, for example, when transitioning from the MF state to tracking AF, the focus position at that time can be recognized.

The depth information detection unit 33 detects depth information of the subject. For example, depth information is defocus information and distance information. As described above, in some cases, a depth map and a defocus map corresponding to each frame of the captured image is generated on the basis of detection information of the distance measuring sensor and defocus information.

Note that defocus information is not limited to the detection method using the image plane phase difference pixel, and may be a separate phase difference method or the like.

The range setting unit 34 is a function of performing setting processing of an in-plane range and a depth range to be described later. For example, the in-plane range and the depth range are set according to a user's operation or automatically.

The object detection unit 35 is a function of performing object detection processing by image analysis of a captured image. For example, detection of face, a pupil, a person (body), an animal, a specific article, or the like is performed in a captured image.

As a method of object detection, an object recognition method such as person detection and animal detection is known, but a method such as semantic segmentation can also be used.

### 3. First Embodiment

Hereinafter, a specific processing example of an embodiment will be described. A processing example of the embodiment is control processing of activating tracking AF from an MF state in response to detection of a predetermined trigger, for example, at the time of capturing a moving image.

First, the necessity of performing such control processing will be described.

Tracking AF executed at the time of capturing a moving image is a function of detecting a subject designated by the imaging device 1 by image signal processing and continuously focusing the detected subject by autofocus in a case where the subject desired to be continuously focused is designated in advance by a user operation, automatic processing, or the like. By using tracking AF, the user can easily keep focusing on a specific subject.

Normally, this tracking AF is provided as a function starting from an autofocus mode. Since autofocus at the time of capturing a moving image is generally provided as continuous AF that operates constantly, it means that tracking AF is started from a state in which a certain part in the screen is in focus.

However, it is not always desired to continuously focus on a specific subject in one scene in moving image capturing. For example, a scene could be staged so that the main subject is not in the screen and the focus is stopped at the beginning of the scene, but the focus follows the main subject in the scene from the middle of the scene.

In order to image such a scene, conceivable methods include:
(a) obtaining a desired focus state by performing a manual focus operation from the beginning to the end;
(b) performing manual focusing at first to stop focusing, and switching to autofocus after a while to control focus; and
(c) performing manual focusing at first to stop focusing, switching to autofocus after a while, and then starting tracking AF.

However, in the case of (a), a difficult manual focus operation is required, in the case of (b), adequate autofocus performance is required, and in the case of (c), the number of operation steps increases.

The present embodiment provides processing of more easily enabling such activation of tracking AF from an MF state, for example. In other words, in the case of moving image capturing or the like, there is provided an implementation means capable of seamlessly switching between stopping focus and causing focus to follow a specific subject without a complicated focus operation.

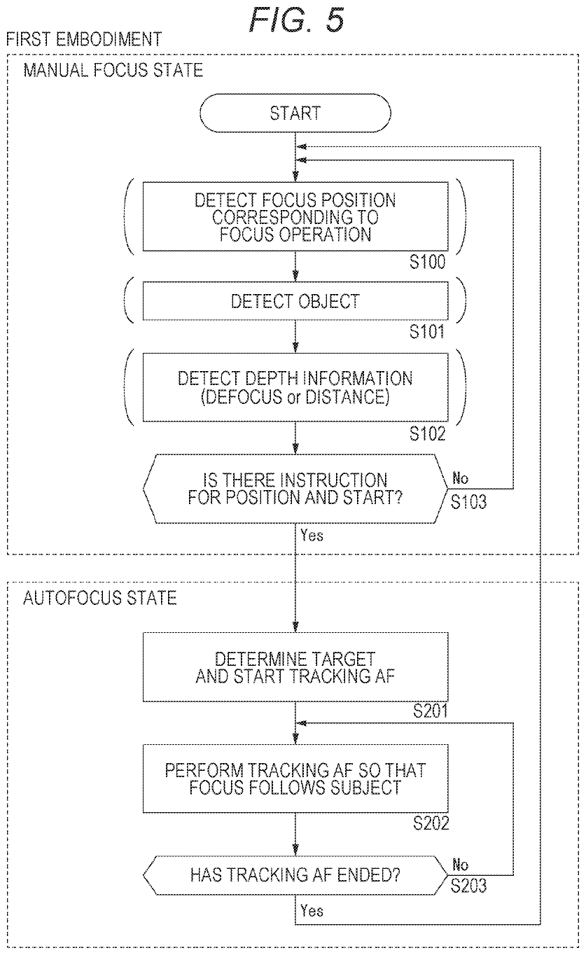

FIG. 5 illustrates an example of control processing of the camera control unit 16. In particular, here, an example of processing of transitioning from the MF state to tracking AF is illustrated.

In the drawing, processing in the manual focus (MF) state and processing in the autofocus (AF) state are both surrounded by broken lines.

Note that the processing in steps S100, S101, and S102 is denoted by ( ) which means optional processing, that is, not essential processing.

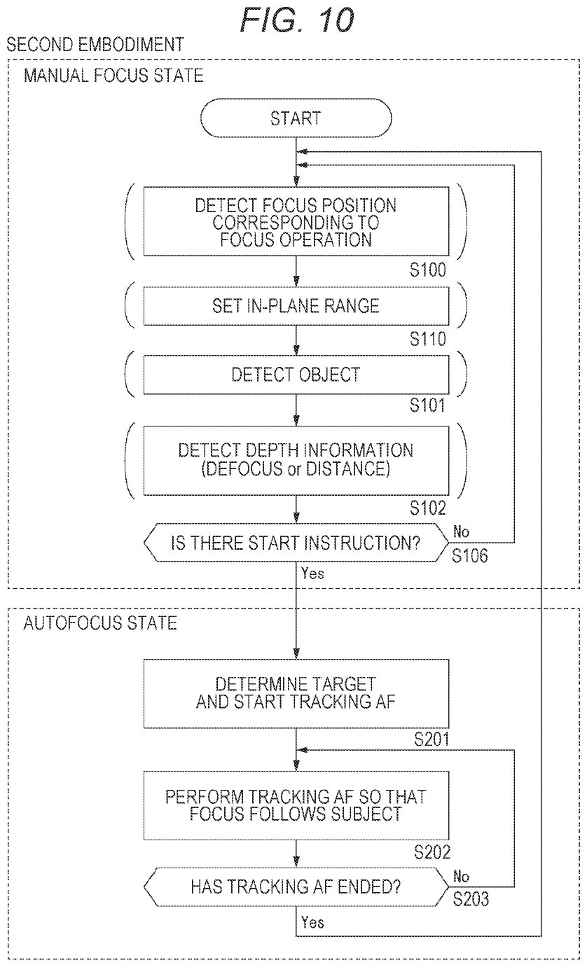

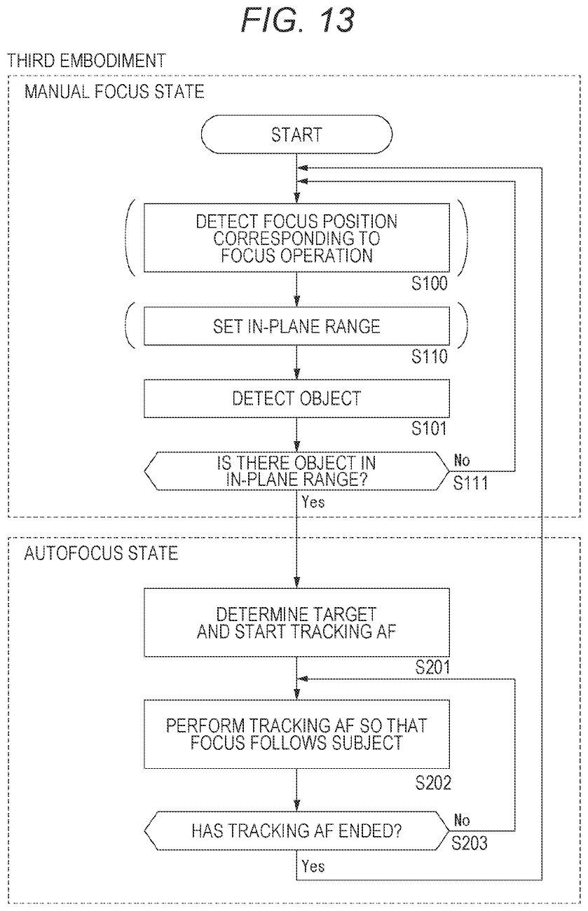

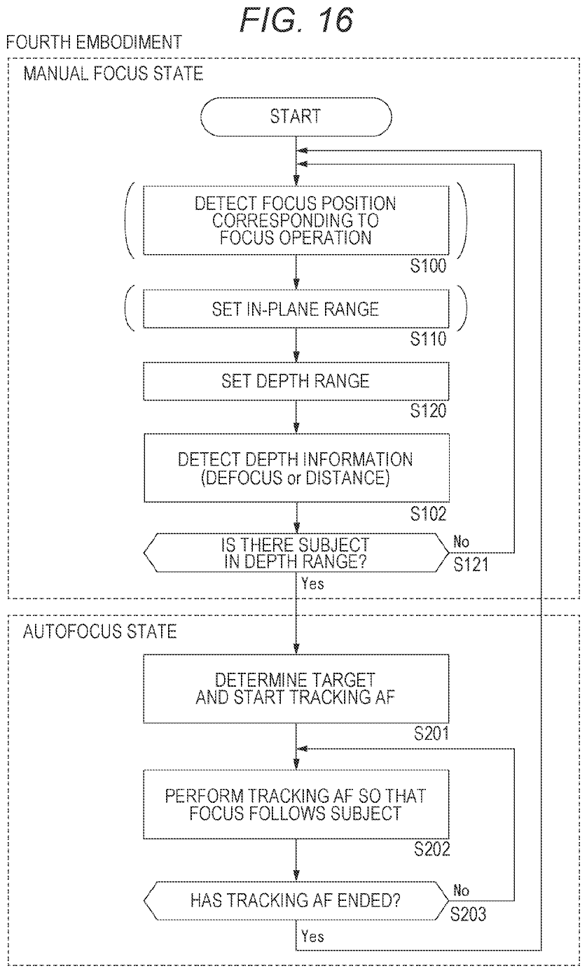

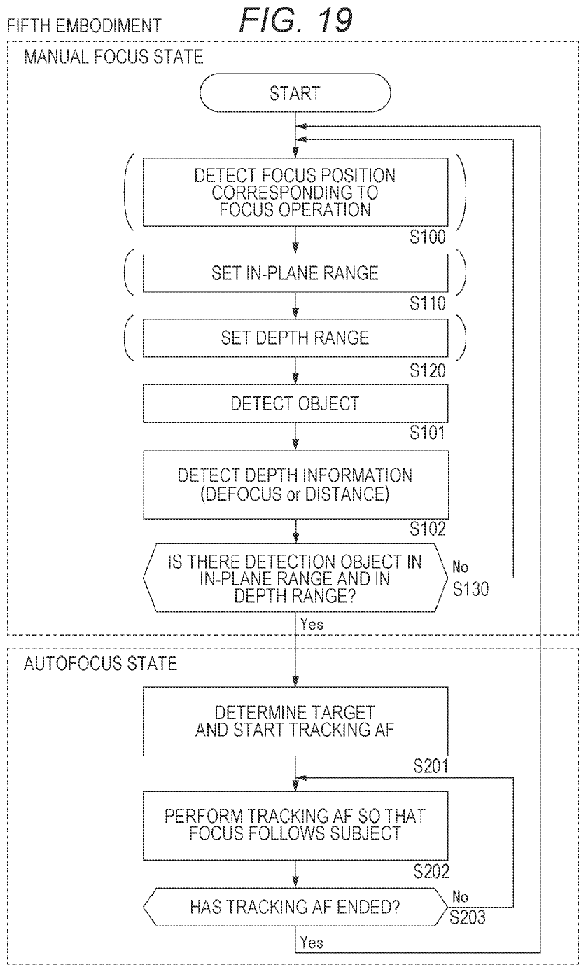

The same applies to the flowcharts (FIG. 10, FIG. 13, FIG. 16, and FIG. 19) of second to fifth embodiments described later.

Then, processing examples of FIG. 5 and the second to fifth embodiments to be described later are processing examples executed by the camera control unit 16 including all or some of functions as the focus control unit 30, the UI control unit 31, the focus position detection unit 32, the depth information detection unit 33, the range setting unit 34, and the object detection unit 35 in FIG. 4.

In the processing of FIG. 5, in the MF state, the camera control unit 16 performs trigger detection in step S103 while sequentially performing the processing of steps S100, S101, and S102.

Step S100 is processing in which the camera control unit 16 detects the current focus position. In the MF state, in a case where the focus lens is driven in response to the user's operation on the focus ring 7, the camera control unit 16 detects the focus position after the driving in step S100. As a result, the camera control unit 16 always grasps the focus position during the MF state period.

For example, in the case of a structure in which the focus lens is mechanically moved in the optical axis direction according to the operation of the focus ring 7 in the lens barrel 3, the camera control unit 16 detects the focus position according to the movement of the focus lens.

Furthermore, for example, in a case of a structure in which the camera control unit 16 performs motor drive control according to the operation of the focus ring 7 and moves the focus lens in the optical axis direction, the camera control unit 16 detects the focus position while performing focus lens movement control according to the operation of the focus ring 7.

In step S101, the camera control unit 16 performs object detection processing. The object detection processing is executed by the camera control unit 16, for example, for each frame or for each of intermittent frames of the captured image, and detects a specific object among the subjects. For example, a face, a body, a pupil, and the like are detected in an image of one frame.

In the object detection processing, not only a person but also an animal or a specific animal may be detected, or a specific object such as a car, a flight vehicle, a ship, or other articles may be detected.

Furthermore, one object may be detected in one frame, or a plurality of objects may be detected in one frame.

Moreover, the camera control unit 16 may set a priority order for objects to be detected. For example, a person's face is prioritized, an animal is prioritized, or the like. Various objects and parts may be prioritized. For example, in the case of detecting a person, priority is given in the order of the pupil, the face, and the body.

In step S102, the camera control unit 16 performs processing of detecting a defocus value or a distance as depth information. This processing detects depth information for a subject. The camera control unit 16 executes this processing, for example, for each frame or for each of intermittent frames of the captured image. Note that defocus information is information corresponding to a distance from the focus position, and thus can be used as depth information.

By the processing in step S102, the depth information of the entire area in the frame may be obtained as, for example, a defocus map or a depth map, or the depth information of a partial area in the frame may be detected so that, for example, the defocus value or the distance value of the object detected in the object detection in step S101 is determined.

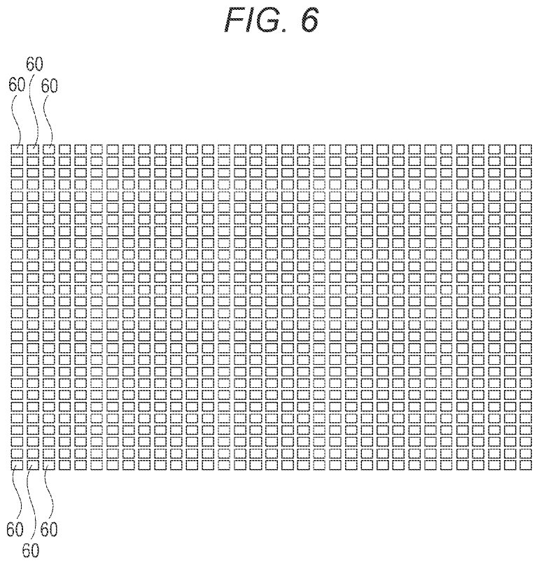

FIG. 6 illustrates an example of a case where the depth information (defocus value or distance value) is obtained over the entire area in the frame. The depth information is detected for each detection block 60 in the plane of the image of one frame. One detection block 60 corresponds to an area of one or a plurality of pixel groups. A depth map and a defocus map can be generated by detecting the depth information for each detection block 60 on the basis of the detection value of the distance measuring sensor and the detection value of the defocus amount.

Note that the depth map can be generated by distance measurement information of each detection block 60. Furthermore, the defocus map based on the defocus information of each detection block 60 can be converted into a depth map.

As described above, during the period in which trigger detection in step S103 is not performed in the MF state, the camera control unit 16 executes steps S100, S101, and S102. Note, however, that in the first embodiment, these are optional processing, and may be omitted in the MF state. In a case where each of a focus position, a detection object, and distance information is used at the time of determining the target of tracking AF in step S201 to be described later, it is only required to execute some or all of steps S100, S101, and S102 as necessary.

In addition, the processing of steps S100, S101, and S102 is not limited to being sequentially performed in the MF state, and may be executed as necessary, for example, after the trigger is detected in step S103.

In step S103, as trigger detection, the camera control unit 16 monitors instructions for position and start. This is processing of detecting, by a user operation, an instruction to start tracking AF and an instruction of an in-plane position as a target of tracking AF. An in-plane position is a position in one screen of a frame (image).

For example, the camera control unit 16 monitors a user's touch operation (or an equivalent operation) on the through image displayed on the rear monitor 4.

The touch operation itself serves as an instruction to start tracking AF, and the touched position on the rear monitor 4 serves as an instruction of the in-plane position as a target of tracking AF.

For example, when detecting a trigger by a touch operation, the camera control unit 16 proceeds from step S103 to step S201, determines a target, and starts tracking AF control.

An example of determining the target is as follows. An example of target determination will be described as (TG11) to (TG18).

Note that in each example, a case where a “subject” is targeted and a case where a “detection object” is targeted are described. Targeting a “subject” means, for example, targeting features (color, design, and the like) of the subject at a corresponding position, and targeting a “detection object” means targeting an object detected as a specific subject by the object detection processing among the subjects.

(TG11) Target a subject at a designated position.

For example, a color, a design, a pattern, and other features as a subject at an in-plane position designated by a touch operation are detected and targeted.

Note that in this case, the camera control unit 16 does not need to execute the processing of steps S100, S101, and S102.

(TG12) Target a detection object in the vicinity of the designated position.

A detection object at or near an in-plane position designated by the user is targeted. The reason why the target is set near the designated position is because the user does not necessarily touch the position of the detection object accurately. If the user touches the vicinity of the “face” in the screen, for example, the camera control unit 16 determines the “face” as a target.

Note that the camera control unit 16 performs the object detection in step S101 in order to determine the target.

(TG13) Select a target from a plurality of detection objects in the vicinity of the designated position using a size condition.

This is an example in which, in a case where there is a plurality of detection objects near the in-plane position designated by the user, a target is determined from among the plurality of detection objects according to a size condition. The size may be regarded as an area in the screen. The size may be regarded as the number of pixels corresponding to the detection object.

For example, in a case where a plurality of people is the subject, the face of a person closest to the imaging device 1 has the largest size, and the face of a person farthest from the imaging device 1 has the smallest size. The target is selected according to such an in-plane size. For example, a detection object having the largest size is targeted. There is also an example in which a detection object having the smallest size is targeted, as a matter of course. Alternatively, in a case where there are three or more detection objects, there is an example in which a detection object having a center size and an intermediate size is targeted.

Note that in order to make this target determination (TG13), the camera control unit 16 performs the object detection in step S101.

(TG14) Select a target from a plurality of detection objects in the vicinity of the designated position using a priority condition.

This is an example in which, in a case where there is a plurality of detection objects near the in-plane position designated by the user, a target is determined by the priority condition of the object type. The priority condition may be set in advance or may be arbitrarily set by the user. For example, as the priority order, an example in which “1: pupil”, “2: face”, and “3: body” are set, an example in which “1: woman” and “2: male” (or vice versa) are set, an example in which “1: smiling face” and “2: non-smiling face” are set, an example in which “1: animal” and “2: person” are set, and the like are assumed. These may be set according to the purpose of imaging or the like.

Then, for example, in a case where there is a plurality of detection objects, a detection object having the highest priority among the detection objects is targeted.

Note that in order to make this target determination (TG14), the camera control unit 16 performs the object detection in step S101.

(TG15) Select a target from a plurality of detection objects in the vicinity of the designated position using a focus position.

In a case where there is a plurality of detection objects near the in-plane position designated by the user, an example is considered in which the target is determined by comparison with the focus position at that time, that is, the focus position set by the user in the MF state. Specifically, a detection object whose distance in the depth direction is closest to the focus position is targeted. As a result, tracking AF can be smoothly started for the detection object close to the focus position set by MF.

Note that other examples of target selection using the focus position, such as targeting a detection object farthest from the focus position or a detection object close to a position separated from the focus position by a predetermined distance, are also conceivable.

In order to make this target determination (TG15), the camera control unit 16 performs the object detection in step S101, the focus position detection in step S100, and the detection of depth information in step S102.

(TG16) Select a target from a plurality of detection objects in the vicinity of the designated position using depth information (defocus information or distance information).

In a case where there is a plurality of detection objects near the in-plane position designated by the user, a target is determined by the depth information of each detection object. For example, the closest detection object (closest to the imaging device 1) is targeted. As a result, a person or the like close to the imaging device 1 can be targeted. In the case of the closest detection object, the target is less likely to be lost (become untrackable) in the process of tracking AF.

Note that other examples of target selection using depth information of the detection object, such as targeting the farthest detection object (farthest from the imaging device 1) or the detection object at an intermediate position, are also conceivable.

In order to make this target determination (TG16), the camera control unit 16 performs the object detection in step S101 and the detection of depth information in step S102.

(TG17) Target a subject closest to the focus position in the vicinity of the designated position.

A predetermined range based on the in-plane position designated by the user is defined as the vicinity of the designated position. For example, a range of a predetermined distance in the in-plane direction with the designated position as the center is defined as the vicinity of the designated position. Alternatively, a rectangular range in the in-plane direction may be set around the designated position, and this may be defined as the vicinity of the designated position. Then, a subject whose distance in the depth direction is closest to the focus position in the area defined as the vicinity of the designated position is targeted. That is, a color, a design, a pattern, and other features are detected as the subject closest to the focus position, and are targeted.

In order to make this target determination (TG17), the camera control unit 16 performs the focus position detection in step S100 and the detection of depth information in step S102.

(TG18) Target the closest subject in the vicinity of the designated position.

Similarly to (TG17) described above, a predetermined range based on the in-plane position designated by the user is defined as the vicinity of the designated position. Then, a subject whose distance in the depth direction is the closest to the imaging device 1 in the area defined as the vicinity of the designated position is targeted. That is, a color, a design, a pattern, and other features are detected as the closest subject, and are targeted.

In order to make this target determination (TG18), the camera control unit 16 performs the detection of depth information in step S102.

The above (TG11) to (TG18) are examples, and other target determination examples can be considered. In step S201, the camera control unit 16 performs target determination of the above example and starts tracking AF.

Then, in step S202, the camera control unit 16 performs control processing as the actual tracking AF. That is, focus control is executed such that the focus position follows the target in the subsequent frame.

The control of the tracking AF is continued until it is determined in step S203 that the tracking AF has ended.

In step S203, the camera control unit 16 determines that tracking AF has ended. For example, in a case where there is an end of tracking AF, an end of imaging, a mode change, or the like as a user operation, it is determined that the tracking AF has ended. In addition, in a case where following is disabled during execution of tracking AF, it may be determined that tracking AF has ended. For example, the target may go out of frame and cannot be followed. Furthermore, there is a case where the tracking AF is ended on the assumption that the target subject cannot be followed. For example, in a case where a subject at a position specified by a user operation is targeted, but the subject range to be followed cannot be clearly identified, the tracking AF may be ended.

In a case where it is determined that tracking AF has ended, in the example of FIG. 5, the camera control unit 16 returns to, for example, step S100 and enters the MF state. Alternatively, the processing of FIG. 5 may be ended without returning to the MF state, and the AF mode may be set.

The same applies to the second to fifth embodiments described later.

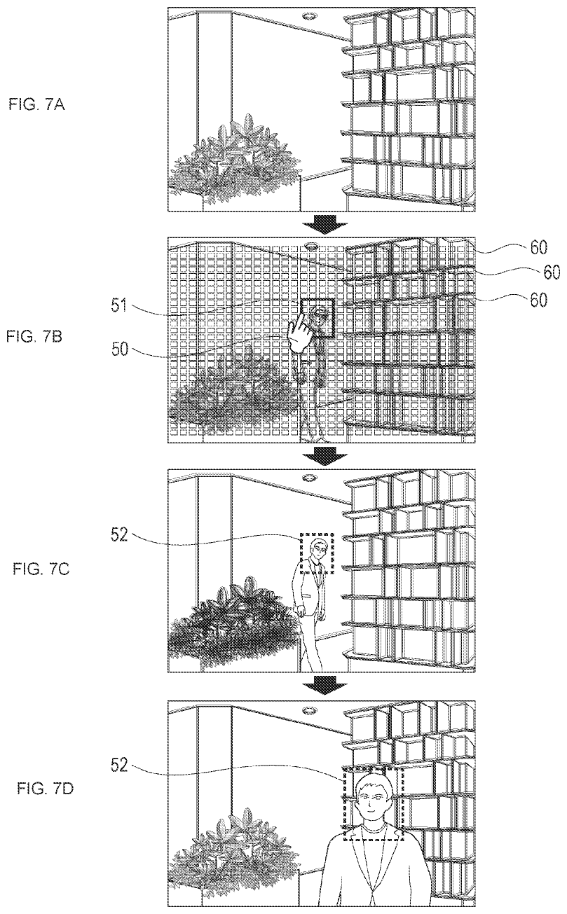

An operation example of such tracking AF achieved by the processing of FIG. 5 will be described with reference to FIGS. 7A to 7D. FIGS. 7A to 7D illustrate display examples of captured images in the course of the processing of FIG. 5.

FIG. 7A illustrates a state in which a certain position is in focus in the MF state. That is, a certain focal length is fixed by MF. This is a processing period from step S100 to step S103 in FIG. 5.

For example, in the period of the MF state, in a case where the depth information detection processing is performed in step S102, distance measurement or defocus amount detection is performed for each detection block 60 as illustrated in FIG. 7B. Note that while the detection block 60 is illustrated in FIG. 7B for the sake of explanation, the detection block 60 is not displayed on the screen of the rear monitor 4.

Furthermore, for example, in the period of the MF state, there is a case where the object detection processing is performed for each frame in step S101. FIG. 7B illustrates an example in which the face is detected and a detection frame 51 is displayed. By displaying the detection frame 51, the user can know that, for example, a face or the like has been detected in the image by the object detection processing.

The user can perform a touch operation 50. For example, the vicinity of the detection frame 51 is touched.

The camera control unit 16 detects the touch operation 50 as a trigger in step S103 in FIG. 5, and proceeds to step S201.

For example, as illustrated in FIG. 7C, tracking AF is started with the detected face as a target. In this case, the camera control unit 16 displays a tracking frame 52 in the range of the target subject, so that the user can know that tracking AF is started and know the target of the tracking AF.

Thereafter, the focus is caused to follow the target by tracking AF control. FIG. 7D illustrates a state in which the tracking frame 52 performs following and tracking AF is performed even when the depth or the in-plane position of the target changes.

As described above, tracking AF is smoothly activated according to the user's operation from the MF state.

Incidentally, an example of mode setting for executing the processing as illustrated in FIG. 5 will be described. In order to cause the camera control unit 16 to execute the processing of FIG. 5, it is conceivable that the user sets the focus mode to the MF mode and then performs setting using a touch operation as a trigger of the start and position of tracking AF.

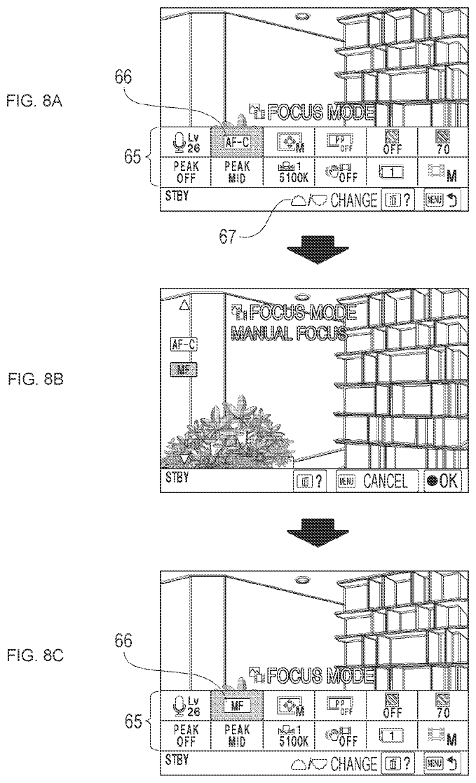

First, the focus mode is set to the MF mode. FIG. 8A illustrates an example in which a function menu 65 is displayed on the rear monitor 4. At this time, if the AF mode is selected, “AF-C” (continuous AF) is displayed as a focus mode item 66. The user selects the focus mode item 66 in the function menu 65 and operates a change key 67. This allows the user to select one of the icons of “AF-C” and “MF” in FIG. 8B. When the user selects “MF”, the focus mode item 66 is set to “MF” in the function menu 65 as illustrated in FIG. 8C, and the manual focus mode is selected.

Note that while the above is an operation example of mode selection using the function menu 65, the focus mode may be configured to be more easily selectable by providing the operation element 6 for selecting the focus mode or using the custom key 6C.

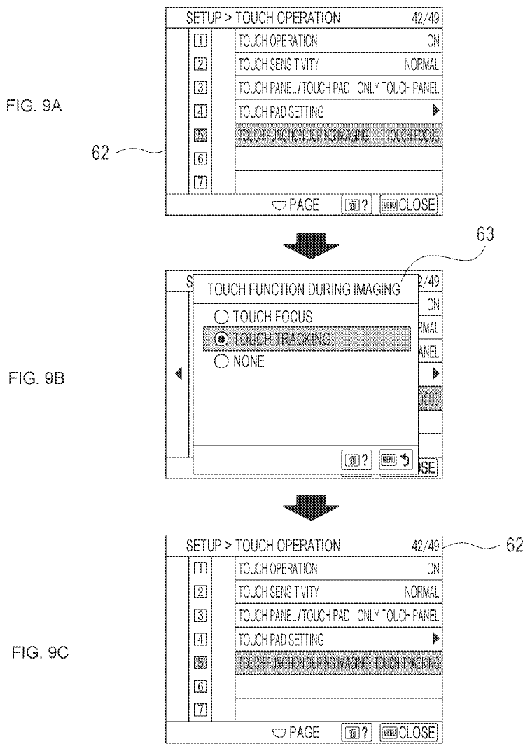

After selecting the MF mode in this manner, the user sets the touch function. FIG. 9A illustrates a state in which a menu 62 is displayed. At this point, assume that the item “touch function during imaging” in the menu 62 is set to “touch focus”.

The user selects “touch function during imaging” on the menu 62. As a result, a sub-menu 63 of FIG. 9B is displayed. The user selects “touch tracking” in the sub-menu 63. Then, when the display returns to the menu 62, as illustrated in FIG. 9C, the item “touch function during imaging” in the menu 62 is set as “touch tracking”.

With such an operation, the touch operation is set as a trigger of tracking AF.

With the above setting, the processing of FIG. 5 can be executed.

Note that the setting of the touch function can be changed by an operation other than the operation using the menu 62 described above. For example, the setting of the touch function can be changed by an operation using a predetermined operation element 6.

Note that “MF” as in FIG. 8C indicates a general manual focus mode, and does not indicate that the mode transitions to tracking AF by a touch operation. By selecting “touch tracking” as illustrated in FIG. 9C, the processing of FIG. 5 is performed. This makes it possible to distinguish between general MF and MF in FIG. 5.

That is, in general MF, focus lens driving is simply performed according to the operation of the focus ring 7, but by selecting “touch tracking”, tracking AF can be activated by a touch operation. That is, the user can selectively use normal MF that does not activate tracking AF and MF that activates tracking AF by a trigger of a touch operation as illustrated in FIG. 5.

Note that as the focus mode, in addition to the MF mode and the AF mode, a mode for switching from MF as illustrated in FIG. 5 to tracking AF by a predetermined trigger may be prepared so that the user can arbitrarily select the mode.

### 4. Second Embodiment

FIG. 10 illustrates a processing example of a second embodiment. Note that in the following flowcharts, processing already described is denoted by the same step number, and redundant detailed description is avoided.

In the MF state, a camera control unit 16 performs trigger detection in step S106 while sequentially performing processing in steps S100, S110, S101, and S102 in FIG. 10.

In this case, in addition to step S100 (focus position detection), step S101 (object detection), and step S102 (detection of depth information) in FIG. 5 described above, an in-plane range for starting tracking AF is set in step S110.

Note that the processing of steps S100, S110, S101, and S102 is not limited to being sequentially performed in the MF state, and may be executed as necessary, for example, after the trigger is detected in step S106.

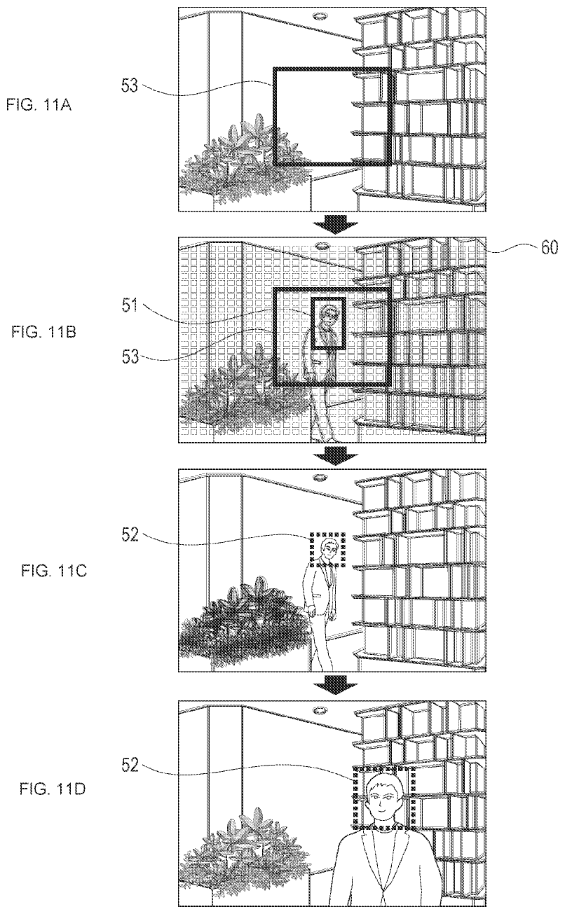

Setting of an in-plane range is setting of a range in an image of one frame. FIG. 11A illustrates an example in which a certain in-plane range is set as an in-plane range frame 53. In the second embodiment, this in-plane range is used to determine a subject for which tracking AF is started, that is, a target.

The in-plane range may be set in response to the user performing an operation of displaying, moving, or enlarging or reducing the in-plane range frame 53 at an arbitrary time point. Alternatively, the camera control unit 16 may automatically perform the setting. For example, a predetermined size or the like may be set at the center position in the plane.

Furthermore, unless otherwise specified, the entire in-plane area may correspond to the in-plane range.

In the example of FIG. 10, the start instruction is monitored as trigger detection in step S106. The camera control unit 16 recognizes an operation of a specific operation element 6 by the user as a trigger. For example, if the operation of a custom key 6C4 is assigned as the trigger operation, the camera control unit 16 monitors the operation of the custom key 6C4 in step S106.

When detecting an operation as a start instruction such as an operation of the custom key 604, for example, the camera control unit 16 proceeds from step S106 to step S201, determines a target, and starts tracking AF control.

An example of determining the target in this case is as follows. An example of target determination will be described as (TG21) to (TG28).

(TG21) Target a subject at the center of the in-plane range.

A color, a design, a pattern, and other features are detected for the subject at the center of the in-plane range in the frame at the time of occurrence of the trigger, and are targeted.

Note that in this case, the camera control unit 16 does not need to execute the processing of steps S100, S101, and S102.

The setting in the in-plane range in step S110 is reflected, but if the in-plane range is not set, the entire image may be treated as the in-plane range. The same applies to the following (TG22) to (TG28).

(TG22) Target a detection object in the in-plane range.

For example, when the “face” is detected in the in-plane range, the camera control unit 16 determines the “face” as a target.

In order to make this target determination (TG22), the camera control unit 16 performs the object detection in step S101.

(TG23) Select a target from a plurality of detection objects in the in-plane range using a size condition.

In a case where there is a plurality of detection objects in the in-plane range, the target is determined according to a size condition. A size is an area in the screen. Then, for example, a detection object having the largest size in the in-plane range is targeted. There is an example in which a detection object having the smallest size in the in-plane range is targeted, and there is an example in which a detection object having a center size or an intermediate size is targeted in a case where there are three or more detection objects in the in-plane range.

In order to make this target determination (TG23), the camera control unit 16 performs the object detection in step S101.

(TG24) Select a target from a plurality of detection objects in the in-plane range using a priority condition.

In a case where there is a plurality of detection objects in the in-plane range, a target is determined by the priority condition of the object type. In a case where there is a plurality of detection objects in the in-plane range, a detection object having the highest priority among the detection objects is targeted.

In order to make this target determination (TG24), the camera control unit 16 performs the object detection in step S101.

(TG25) Select a target from a plurality of detection objects in the in-plane range using a focus position.

In a case where there is a plurality of detection objects in the in-plane range, the target is determined by comparison with the focus position at that time, that is, the focus position set by the user in the MF state. For example, a detection object that is in an in-plane range and whose distance in the depth direction is closest to the focus position is targeted. As a result, tracking AF can be smoothly started for the detection object in the focus position set by MF.

Note that other examples of target selection using the focus position, such as targeting a detection object that is in the in-plane range and farthest from the focus position or a detection object that is in the in-plane range and close to a position separated from the focus position by a predetermined distance, are also conceivable.

In order to make this target determination (TG25), the camera control unit 16 performs the object detection in step S101, the focus position detection in step S100, and the detection of depth information in step S102.

(TG26) Select a target from a plurality of detection objects in the in-plane range using depth information (defocus information or distance information).

In a case where there is a plurality of detection objects in the in-plane range, a target is determined by the depth information of each detection object. For example, the closest detection object (closest to the imaging device 1) is targeted. As a result, a person or the like close to the imaging device 1 can be targeted.

Note that other examples of target selection using depth information of the detection object, such as targeting the farthest detection object (farthest from the imaging device 1) or the detection object at an intermediate position, are also conceivable.

In order to make this target determination (TG26), the camera control unit 16 performs the object detection in step S101 and the detection of depth information in step S102.

(TG27) Target a subject closest to the focus position in the in-plane range.

A subject whose distance in the depth direction is closest to the focus position in the in-plane range is targeted. That is, a color, a design, a pattern, and other features are detected as the subject closest to the focus position, and are targeted.

In order to make this target determination (TG27), the camera control unit 16 performs the focus position detection in step S100 and the detection of depth information in step S102.

(TG28) Target the closest subject in the in-plane range. A subject whose distance in the depth direction is closest to the imaging device 1 in the in-plane range is targeted. That is, a color, a design, a pattern, and other features are detected as the closest subject, and are targeted.

In order to make this target determination (TG28), the camera control unit 16 performs the detection of depth information in step S102.

The above is an example, and other target determination examples are conceivable. In step S201, the camera control unit 16 performs target determination of the above example and starts tracking AF.

Then, in step S202, the camera control unit 16 performs control processing as the actual tracking AF, and in step S203, determines the end of the tracking AF.

An operation example of such tracking AF achieved by the processing of FIG. 10 will be described. FIGS. 11A to 11D illustrate display examples of captured images in the course of the processing of FIG. 10.

FIG. 11A illustrates a state in which a certain position is in focus in the MF state. Furthermore, in the processing of step S110 of FIG. 10, the in-plane range is set, and an in-plane range frame 53 is displayed.

FIG. 11B illustrates that, during this MF state period, depth information detection processing is performed for each detection block 60 in step S102, and object detection processing is performed for each frame in step S101, so that a detection frame 51 is displayed according to the detection.

When the user gives a start instruction by operating the custom key 6C4 or the like, the camera control unit 16 detects the operation of the custom key 6C4 or the like as a trigger in step S106 of FIG. 10, and proceeds to step S201.

Then, for example, as illustrated in FIG. 11C, a tracking frame 52 is displayed with the detected face as a target, and tracking AF is started. FIG. 7D illustrates a state in which the tracking frame 52 performs following and tracking AF is performed even when the depth or the in-plane position of the target changes.

As described above, tracking AF is smoothly activated according to the user's operation from the MF state.

Note that in order to execute the processing as illustrated in FIG. 10, an example in which a specific operation element 6 is registered as an instruction to start detection in step S106 will be described.

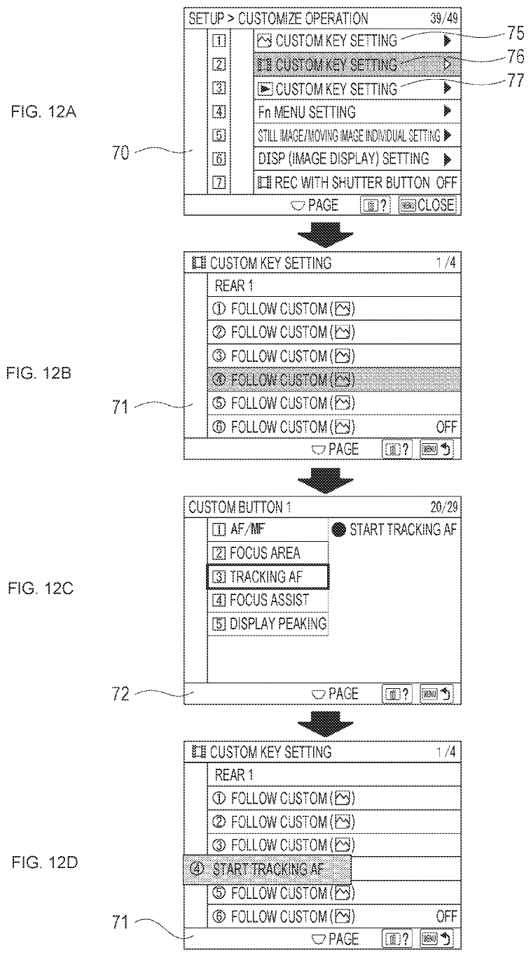

FIG. 12A is an example in which a menu 70 including custom key setting items is displayed on a rear monitor 4, for example. Here, an item 75 of custom key setting of a still image capturing mode, an item 76 of custom key setting of a moving image capturing mode, an item 77 of custom key setting of a reproduction mode, and the like are prepared.

For example, the user selects the custom key setting item 76 in the moving image capturing mode, and displays a sub-menu 71 in FIG. 12B. In the sub-menu 71, items for custom keys 6C1 to 6C6 are prepared. For example, in a case where it is desired to assign a custom key 604, the user selects the custom key 6C4. As a result, a selection menu 72 is displayed as illustrated in FIG. 12C, and, for example, “start tracking AF” is selected.

As a result, in the moving image capturing mode, the custom key 6C4 is assigned to the operation element for giving an instruction to start tracking AF.

Thereafter, if the user selects the MF mode by selecting the focus mode as described above with reference to FIG. 8, the user can activate tracking AF by pressing the custom key 6C4 at an arbitrary time point.

That is, as the MF mode, the manual focus operation can be performed normally, and the tracking AF can be started at a time point desired by the user.

### 5. Third Embodiment

FIG. 13 illustrates a processing example of a third embodiment. This is an example in which tracking AF is automatically activated by a trigger based on object detection.

In the MF state, a camera control unit 16 performs trigger detection in step S111 while sequentially performing the processing of step S100 (focus position detection), step S110 (in-plane range setting), and step S101 (object detection) in FIG. 13.

As the trigger detection in step S111, the camera control unit 16 determines whether or not there is a detection object in the in-plane range.

That is, in a case where a detection object is confirmed by the object detection processing in step S101, it is determined whether or not the detection object is in the in-plane range. Note that in a case where the in-plane range is not set, the entire area in the image may be set as the in-plane range.

When determining that there is a detection object in the in-plane range, the camera control unit 16 proceeds from step S111 to step S201 with the determination as a trigger, determines a target, and starts tracking AF control.

Examples of target determination in this case include (TG22), (TG23), and (TG24) described in the second embodiment described above.

(TG22) Target a detection object in the in-plane range.

(TG23) Select a target from a plurality of detection objects in the in-plane range using a size condition.

(TG24) Select a target from a plurality of detection objects in the in-plane range using a priority condition.

The above is an example, and other target determination examples are conceivable. In step S201, the camera control unit 16 performs target determination of the above example and starts tracking AF.

Then, in step S202, the camera control unit 16 performs control processing as the actual tracking AF, and in step S203, determines the end of the tracking AF.

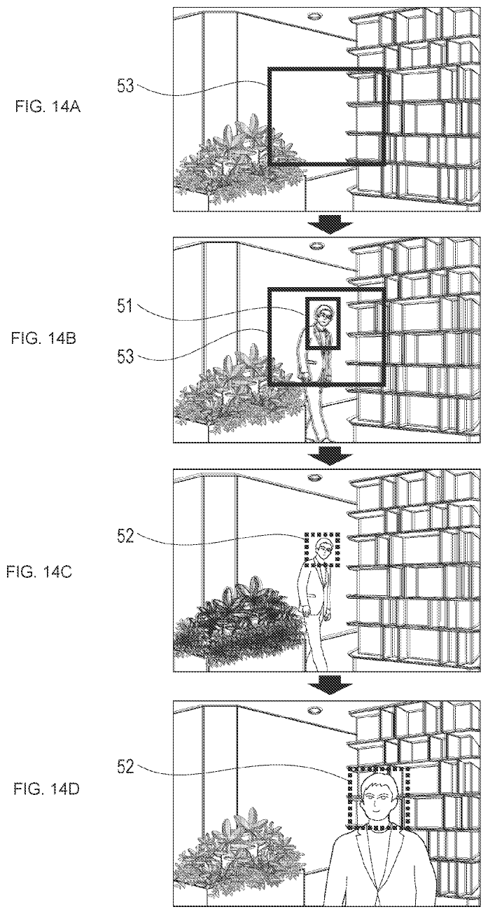

An operation example of such tracking AF achieved by the processing of FIG. 13 will be described. FIGS. 14A to 14D illustrate display examples of captured images in the course of the processing of FIG. 13.

FIG. 14A illustrates a state in which a certain position is in focus in the MF state. Furthermore, in the processing of step S110 of FIG. 13, the in-plane range is set, and an in-plane range frame 53 is displayed.

FIG. 14B illustrates that, during this MF state period, object detection processing is performed for each frame in step S101, so that a detection frame 51 is displayed according to the detection.

When determining that the detection object has entered the in-plane range frame 53 as illustrated in FIG. 14B, the camera control unit 16 proceeds to step S201 with this determination as a trigger in step S111 in FIG. 13.

Then, the target is determined, for example, a tracking frame 52 is displayed as illustrated in FIG. 14C, and tracking AF is started. FIG. 14D illustrates a state in which the tracking frame 52 performs following and tracking AF is performed even when the depth or the in-plane position of the target changes.

As described above, the tracking AF is automatically activated from the MF state.

Note that, as a method of object detection by image processing, an object recognition method such as person detection and animal detection is known, but detection may be performed in which a segment is regarded as one object by a semantic segmentation method.

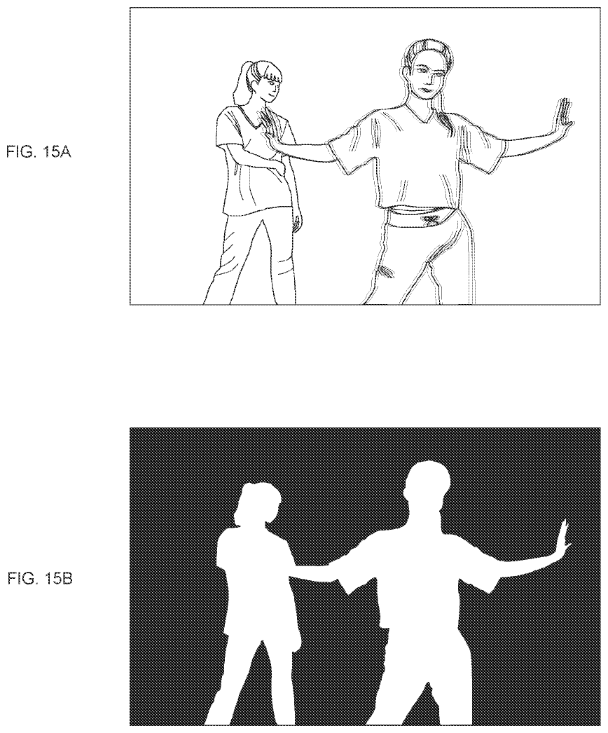

FIG. 15B illustrates an example in which a pixel range equivalent to the distance range of the image in FIG. 15A is detected as a segment (white portion in the drawing) and is determined as an object. That is, class identification is performed for each pixel, and the entire image is divided into segments. The class of class identification includes a person, an object, sky, sea, and the like. More detailed classification of classes is also possible.

### 6. Fourth Embodiment

FIG. 16 illustrates a processing example of a fourth embodiment. This is an example in which tracking AF is automatically activated by a trigger based on depth information.

In the MF state, a camera control unit 16 performs trigger detection in step S121 while sequentially performing the processing of step S100 (focus position detection), step S110 (in-plane range setting), step S120 (depth range setting), and step S102 (detection of depth information) in FIG. 16.

In this example, step S120 (depth range setting) and step S102 (detection of depth information) are essential processing.

Depth range setting in step S120 means setting a specific range as a distance in the depth direction as a range in which tracking AF is started.

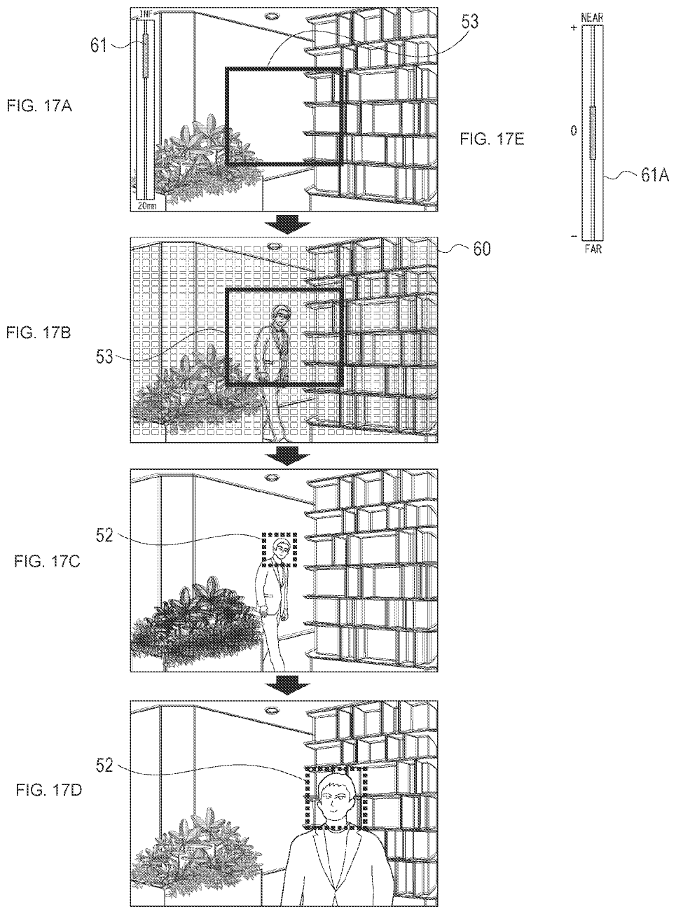

For example, FIG. 17A illustrates a depth range setting bar 61 on the screen. The depth range setting bar 61 indicates, for example, 20 mm to infinity (INF) as the distance in front of the imaging device 1, and allows the user to arbitrarily designate the range of the distance in the depth direction by an operation on the bar. In accordance with the operation of the depth range setting bar 61, the camera control unit 16 sets the depth range in step S120. With the depth range setting bar 61, the set depth range is also clearly indicated on the bar.

The depth range setting bar 61 illustrated in FIG. 17A is an example of setting the depth range by the distance from the imaging device 1, but a depth range setting bar 61A as illustrated in FIG. 17E is also conceivable. This sets the depth range by a defocus value. For example, an arbitrary range can be designated on the+(near) side and the−(far) side in units of depth (blur amount) with “0” at the center of the bar as the current focus position. Note that the position on the +side and the position on the−side of the range setting in the depth range setting bar 61A can be freely set from the end on the near side to the end on the far side. For example, if the maximum value of the depth on the near side is “+10” and the maximum value of the depth of the far end is “−10”, the user can freely set the range as in examples such as “+5 to −5”, “+2” to “−1”, “−10” to “−7”, and “+3” to “+5”. Moreover, the positions on the +side and the−side may be made to coincide with each other, and the depth range may be set from “+1” to “+1”.

Note that such an operation method by the user is an example, and a method of a setting operation using schemes other than the depth range setting bars 61 and 61A is also conceivable.

Note, however, that the distance specified by the depth range setting bar 61 or the like may be difficult for the user to grasp. It is difficult for the user to grasp in what distance range the tracking AF can be activated with respect to a desired subject only by looking at the depth range setting bar 61.

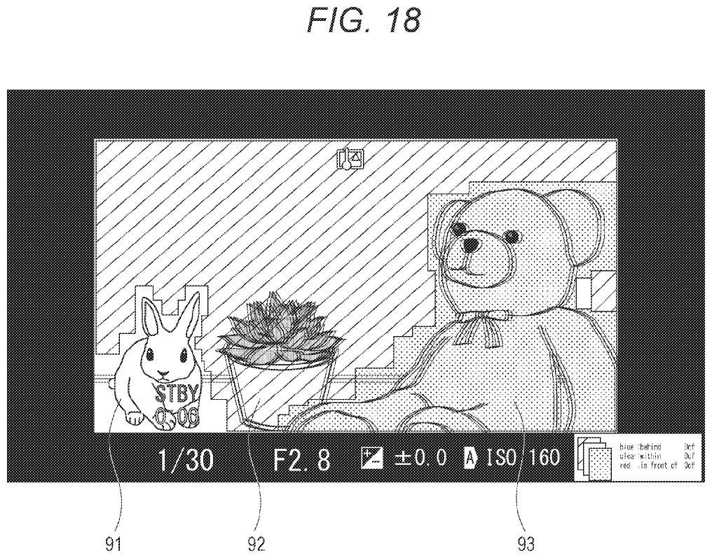

Hence, the setting state may be represented by a color map as illustrated in FIG. 18.

In this example, assume that a subject 91 is within a set depth range, a subject 92 is on the side farther than the depth range, and a subject 93 is on the side closer than the depth range. For example, an area showing a subject within the depth range including the subject 91 is displayed normally. On the other hand, an area showing a subject farther than the depth range including the subject 92 is displayed in blue (indicated as a hatched portion), and an area showing a subject closer than the depth range including the subject 93 is displayed in red (indicated as a dotted portion).

For example, by performing the color map display in this manner, the perspective relationship of each subject can be seen in the screen, and can be used as a reference for the user to set the depth range.

Note that the depth range may be automatically set by the camera control unit 16. For example, in a period in which the depth range is not designated by the user, the camera control unit 16 may set a prescribed depth range.

The detection of the depth information (defocus information or distance information) in step S102 is essential processing in the example of FIG. 16. In particular, in this case, it is conceivable to generate a depth map by using defocus information or distance information obtained by distance measurement.

As the trigger detection in step S121, the camera control unit 16 determines whether or not there is a subject that can be a target of tracking AF in the depth range.

That is, for each pixel (or the unit of the detection block 60) of a frame, the detection value of the depth information in step S102 is referred to, and whether or not there is a pixel (subject) corresponding to the distance within the depth range is confirmed.

When determining that the there is a subject within the depth range, the camera control unit 16 proceeds from step S121 to step S201 with the determination as a trigger, determines a target, and starts tracking AF control.

An example of determining the target in this case is as follows. An example of target determination will be described as (TG31) to (TG36).

(TG31) Target a subject in the depth range.

A color, a design, a pattern, and other features are detected for the subject in the depth range in the frame at the time of occurrence of the trigger, and are targeted.

Note that in this case, the camera control unit 16 does not need to execute the processing of steps S100 and S110.

(TG32) Target a subject closest to the focus position in the depth range.

A subject whose distance in the depth direction is closest to the focus position in the depth range is targeted.

In order to make this target determination (TG32), the camera control unit 16 performs the focus position detection in step S100. On the other hand, it is not necessary to execute the processing of step S110.

(TG33) Target the closest subject in the depth range.

A subject whose distance in the depth direction is closest to the imaging device 1 in the depth range is targeted.

In the case of the target determination (TG33), the camera control unit 16 does not need to execute the processing of steps S100 and S110.

(TG34) Target a subject in the depth range and in the in-plane range.

Among the subjects in the depth range in the frame at the time of occurrence of the trigger, the subject in the in-plane range is targeted.

With this processing, tracking AF can be activated when a certain subject enters the depth range and also enters the in-plane range.

Note that in this case, the camera control unit 16 executes the processing of step S110. On the other hand, it is not necessary to execute the processing of step S100.

(TG35) Target a subject closest to the focus position in the depth range and in the in-plane range.

Among the subjects within the depth range and in the in-plane range in the frame at the time of occurrence of the trigger, a subject whose distance in the depth direction is closest to the focus position is targeted.

In order to make this target determination (TG35), the camera control unit 16 needs to perform the processing of steps S100 and S110.

(TG36) Target the closest subject in the depth range and in the in-plane range.

A subject in the depth range and in the in-plane range in the frame at the time of occurrence of the trigger and whose distance in the depth direction is the closest to the imaging device 1 is targeted.

In the case of the target determination (TG36), the camera control unit 16 performs the processing of step S110. On the other hand, it is not necessary to execute the processing of step S100.

The above is an example, and other target determination examples are conceivable. In step S201, the camera control unit 16 performs target determination of the above example and starts tracking AF.

Then, in step S202, the camera control unit 16 performs control processing as the actual tracking AF, and in step S203, determines the end of the tracking AF.

An operation example of such tracking AF achieved by the processing of FIG. 16 will be described. FIGS. 17A to 17D illustrate display examples of captured images in the course of the processing of FIG. 16.

FIG. 17A illustrates a state in which a certain position is in focus in the MF state. Furthermore, in a case where the in-plane range is set in the processing of step S110, an in-plane range frame 53 is displayed. Furthermore, the depth range setting bar 61 is displayed for the operation of the depth range, and can be operated by the user. In addition, the currently set depth range is displayed on the depth range setting bar 61.

FIG. 17B illustrates that the detection processing of the depth information is performed for each detection block 60 in step S102 during the MF state.

When detecting a subject within the depth range, the camera control unit 16 proceeds to step S201 with this determination as a trigger in step S121 of FIG. 16.

Then, the target is determined, for example, a tracking frame 52 is displayed as illustrated in FIG. 17C, and tracking AF is started. FIG. 17D illustrates a state in which the tracking frame 52 performs following and tracking AF is performed even when the depth or the in-plane position of the target changes.

As described above, the tracking AF is automatically activated from the MF state.

### 7. Fifth Embodiment

FIG. 19 illustrates a processing example of a fifth embodiment. This is an example in which tracking AF is automatically activated by a trigger based on object detection and depth information.

In the MF state, a camera control unit 16 performs trigger detection in step S130 while sequentially performing the processing of step S100 (focus position detection), step S110 (in-plane range setting), step S120 (depth range setting), step S101 (object detection), and step S102 (detection of depth information) in FIG. 19.

In this example, step S101 (object detection) and step S102 (detection of depth information) are essential processing.

As the trigger detection in step S130, the camera control unit 16 determines whether or not there is a detection object in the in-plane range and in the depth range.

That is, it is confirmed whether or not the detection object is in the in-plane range and whether or not the detection object is in the depth range with reference to the result of the object detection processing.

Note that the fact that steps S110 and S120 are arbitrarily performed in FIG. 19 means that if the in-plane range and the depth range are not set, the trigger detection may be performed over the entire in-plane region or the entire depth region.

When confirming the detection object and determining that there is a detection object in the in-plane range and in the depth range, the camera control unit 16 proceeds from step S130 to step S201 with the determination as a trigger, determines a target, and starts tracking AF control.

An example of determining the target in this case is as follows. An example of target determination will be described as (TG41) to (TG45).

Note that the in-plane range referred to in (TG41) to (TG45) may be considered as the entire image unless otherwise set. That is, “in the in-plane range and in the depth range” can be simply read as “in the depth range”. Furthermore, in (TG44) and (TG45), the depth range can similarly be considered as the entire region in the depth direction unless otherwise set, and the “in the in-plane range and in depth range” can be simply read as “in the in-plane range”.

(TG41) Target a detection object in the in-plane range and in the depth range.

This is an example in which an object detected by the object detection processing and triggered in step S130 is set as a target.

Note that in this case, the camera control unit 16 does not need to execute the processing of step S100.

(TG42) Select a target from a plurality of detection objects in the in-plane range and in the depth range using a size condition.

In a case where there is a plurality of detection objects in the in-plane range and in the depth range, the target is determined according to a size condition. For example, a detection object having the largest size in the corresponding detection objects is targeted. Alternatively, there is an example in which a detection object having the smallest size is targeted, and there is an example in which a detection object having a center size or an intermediate size is targeted in a case where there are three or more corresponding detection objects.

In this case, the camera control unit 16 does not need to execute the processing of step S100.

(TG43) Select a target from a plurality of detection objects in the in-plane range and in the depth range using a priority condition.

In a case where there is a plurality of detection objects in the in-plane range and in the depth range, a detection object having the highest priority according to the priority condition of the object type.

In this case, the camera control unit 16 does not need to execute the processing of step S100.

(TG44) Select a target from a plurality of detection objects in the in-plane range and in the depth range using a focus position.

In a case where there is a plurality of detection objects in the in-plane range and in the depth range, the target is determined by comparison with the focus position at that time, that is, the focus position set by the user in the MF state. For example, among the corresponding detection objects, a detection object whose distance in the depth direction is closest to the focus position is targeted. As a result, tracking AF can be smoothly started for the detection object in the focus position set by MF.

Note that other examples of target selection using the focus position, such as targeting, among the corresponding detection objects, a detection object farthest from the focus position or a detection object close to a position separated from the focus position by a predetermined distance, are also conceivable.

In this case, the camera control unit 16 executes the processing of step S100.

(TG45) Select a target from a plurality of detection objects in the in-plane range and in the depth range using depth information (defocus information or distance information).

In a case where there is a plurality of detection objects in the in-plane range and the in the depth range, a target is determined by the depth information of each detection object. For example, the closest detection object (closest to the imaging device 1) is targeted. As a result, a person or the like close to the imaging device 1 can be targeted.

Note that other examples of target selection using depth information of the detection object, such as targeting the farthest detection object (farthest from the imaging device 1) or the detection object at an intermediate position, are also conceivable.

In this case, the camera control unit 16 does not need to execute the processing of step S100.

The above is an example, and other target determination examples are conceivable. In step S201, the camera control unit 16 performs target determination of the above example and starts tracking AF.

Then, in step S202, the camera control unit 16 performs control processing as the actual tracking AF, and in step S203, determines the end of the tracking AF.

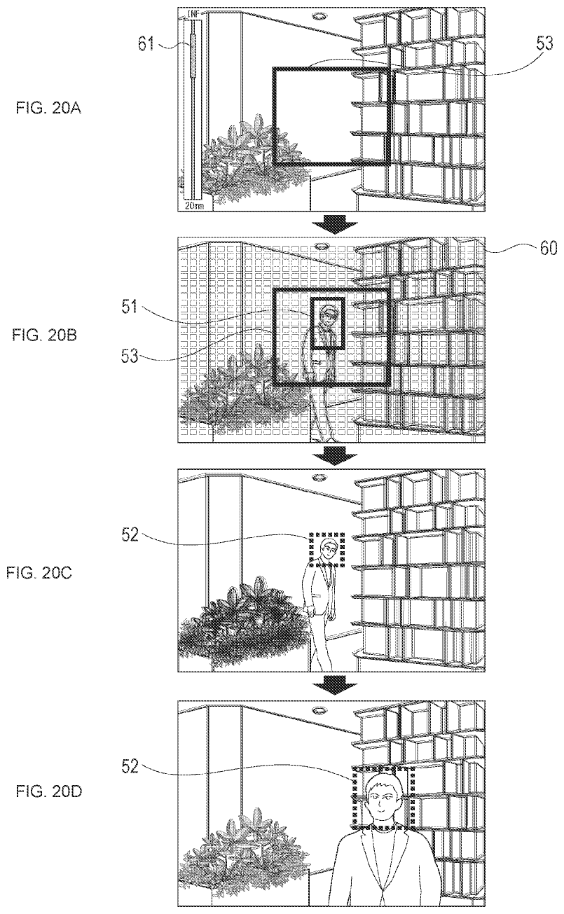

An operation example of such tracking AF achieved by the processing of FIG. 19 will be described. FIGS. 20A to 20D illustrate display examples of captured images in the course of the processing of FIG. 19.

FIG. 20A illustrates a state in which a certain position is in focus in the MF state. Furthermore, in a case where the in-plane range is set in the processing of step S110, an in-plane range frame 53 is displayed. Furthermore, a depth range setting bar 61 is displayed for the operation of the depth range, and can be operated by the user. In addition, the currently set depth range is displayed on the depth range setting bar 61.

FIG. 20B illustrates that the detection processing of the depth information is performed for each detection block 60 in step S102 during the MF state.

Furthermore, during the MF state period, object detection processing is performed for each frame in step S101, so that a detection frame 51 is displayed according to the detection.

When detecting that there is a detection object in the depth range, the camera control unit 16 proceeds to step S201 with this detection as a trigger in step S130 of FIG. 19.

Then, the target is determined, for example, a tracking frame 52 is displayed as illustrated in FIG. 20C, and tracking AF is started. FIG. 20D illustrates a state in which the tracking frame 52 performs following and tracking AF is performed even when the depth or the in-plane position of the target changes.

As described above, the tracking AF is automatically activated from the MF state.

### <8. Summary and Modification>

According to the above embodiments, the following effects can be obtained.

The imaging device according to the embodiment includes the camera control unit 16 that performs trigger detection in an MF state in which focus lens driving based on manual operation is performed, and starts tracking AF processing on the basis of the detection of a trigger.

As a result, it is possible to activate tracking AF for following a specific subject or the like without requiring a complicated operation from a state in which a user such as a camera operator is focusing at an arbitrary distance in the MF state. Therefore, for example, the transition from MF to tracking AF can be smoothly performed during moving image capturing.

Note that while the description has been given mainly assuming that a moving image is captured in the embodiment, the technology related to the transition from MF to tracking AF in the embodiment can be similarly applied to focus control in a still image capturing mode, such as focus control when aiming for a shutter timing.

In the first embodiment, an example has been described in which the trigger for starting the tracking AF is a user operation for designating a position in a screen for displaying a captured image.

The user can activate tracking AF from the MF state by performing a position designation operation such as touching on a display screen in a through image or the like during capturing of a moving image, for example. In this case, the start timing of the tracking AF and the target of the tracking AF can be specified at the same time.

In the second embodiment, an example has been described in which the trigger for starting the tracking AF is an operation of a specific operation element by the user.

A user such as a camera operator can activate tracking AF from the MF state by operating a specific operation element such as a custom key 6C4, for example. In this case, the user can designate the start timing of the tracking AF. In particular, by setting the trigger to an extremely simple operation such as one operation (for example, one push) of a specific operation element such as the custom key 604, the activation of the tracking AF from the MF state can be achieved extremely smoothly.

In the third and fifth embodiments, an example has been described in which the trigger for starting the tracking AF is generated on the basis of object detection processing on the captured image.

In the MF state, for example, when a specific subject such as a face, a pupil, a person, an animal, or a specific object is detected by object detection processing, or when a determination result indicating that a specific subject satisfies a predetermined condition using a depth range, an in-plane range, or the like is obtained as a trigger, the tracking AF is automatically activated. As a result, the tracking AF can be automatically started at a timing suitable for the tracking AF when there is a detection object to be followed or when the detection object is in an appropriate position state, and the operability and convenience of the imaging device 1 can be improved.

In the fourth and fifth embodiments, an example has been described in which the trigger for starting the tracking AF is generated on the basis of sensing information.

In the MF state, sensing of a distance to a subject, a focus state (defocus), and the like is performed, a trigger is generated using the sensing result, and tracking AF is automatically activated. As a result, the tracking AF can be automatically started at an appropriate timing, and the operability and convenience of the imaging device 1 can be improved.

Examples of the sensing information include defocus information (information on blur of a subject) obtained by an image plane phase difference pixel or the like, and distance information obtained by a distance measuring sensor. In addition, illuminance information on the subject side, information on movement of an imaging device obtained by a motion sensor such as an IMU, and the like are conceivable.

For example, the tracking AF may be activated when the subject side becomes bright to a predetermined illuminance, or the tracking AF may be activated by detecting a predetermined movement of the imaging device 1 during imaging.

In particular, as described in the fourth and fifth embodiments, in a case where defocus information or distance information for a subject is used as sensing information, it is easy to start tracking AF at an appropriate timing assumed in advance. For example, at the time of capturing a moving image, when imaging a person that has entered the frame and is approaching from a distant place, it is possible to easily start tracking AF when the person reaches a specific distance.

As described in the third and fifth embodiments, the trigger for starting the tracking AF may be generated on the basis of the setting of the in-plane range as the area in the image plane of the captured image.

In a case where an in-plane range (for example, a range indicated by an in-plane range frame 53) is set in a screen of a captured image, tracking AF is automatically activated, for example, using detection of a specific subject in the in-plane range as a trigger. As a result, the tracking AF can be automatically started at an appropriate timing, and the operability of the imaging device 1 can be improved.

In the second, third, fourth, and fifth embodiments, an example has been described in which the camera control unit 16 performs the presentation control of the in-plane range.

For example, the in-plane range is presented to the user as the in-plane range frame 53. As a result, the user can recognize the setting of the position of the subject to be transitioned to tracking AF. Furthermore, the user can arbitrarily set the in-plane range by selecting the in-plane range frame 53 or changing the size, shape, position, and the like of the in-plane range frame 53.

In the fourth and fifth embodiments, an example has been described in which the trigger for starting the tracking AF is generated on the basis of the setting of the depth range which is the range of the distance to the subject.

In a case where a depth range, which is a range in a distance direction from the imaging device 1 to the subject side, is set, for example, tracking AF is automatically activated by using, as a trigger, that a subject in the depth range is detected, that a detection object is in the depth range, or the like. As a result, the tracking AF can be automatically started at an appropriate timing, and the operability of the imaging device 1 can be improved.

In the fourth and fifth embodiments, an example has been described in which the camera control unit 16 performs presentation control of the depth range.

For example, the depth range is presented as the depth range setting bar 61 in FIGS. 17A and 20A or the color map in FIG. 18. The user can arbitrarily set the depth range using the depth range setting bar 61. Furthermore, it is possible to easily confirm which subject is included in the depth range by the color map.

In the first embodiment, an example has been described in which the camera control unit 16 determines the target of tracking AF processing on the basis of a designated position in the plane of the captured image designated by an operation.

For example, in a case where the user performs an operation of designating a position such as touching on a display screen in a through image or the like during capturing of a moving image, a target of tracking AF is determined on the basis of the designated in-plane position. The following examples are assumed from the description of the embodiment.
Target a subject at a designated position.
Target a detection object present in the designated position.
Target a detection object in the vicinity of the designated position.

While various examples are conceivable in addition to these, the tracking AF operation suitable for the position designation of the user is achieved by determining the target of the tracking AF on the basis of the designated position in this manner.

Furthermore, by targeting the detection object in the vicinity of the designated position, even if the user's touch operation position on the screen slightly deviates from the image of the detection object desired by the user, the object can be targeted, and the operability can be improved.

Note that as described in the embodiment in each example, targeting a “subject” means targeting the color, design, shape, feature point, and the like of the subject as the image, and targeting a “detection object” means targeting an object detected as a specific subject by the object detection processing among the subjects.

In the second, third, fourth, and fifth embodiments, an example has been described in which the camera control unit 16 determines the target of tracking AF processing on the basis of the in-plane range set as the area in the image plane of the captured image.

In a case where an in-plane range (for example, a range indicated by an in-plane range frame 53) is set in the screen of the captured image, a target of tracking AF is determined on the basis of the setting of the in-plane range. The following examples are assumed from the description of the embodiment.
Target a subject at the center of an in-plane range.
Target a detection object present in the in-plane range.
Target a subject (or detection object) present in the in-plane range and in a depth range.
Target the closest subject (or detection object) in the in-plane range.
Target the farthest subject (or detection object) in the in-plane range.
Target the subject (or detection object) closest to the focus position of the MF state at that time in the in-plane range.

While various examples other than these are conceivable, by determining the target using the setting of the in-plane range, the user can determine the range in the screen of the subject for starting the tracking AF.

In the fourth and fifth embodiments, an example has been described in which the camera control unit 16 determines the target of tracking AF processing on the basis of the setting of the depth range which is the range of the distance to the subject.

In a case where a depth range, which is a range in a distance direction from the imaging device 1 to the subject side, is set, a target of tracking AF is determined on the basis of the setting of the depth range. The following examples are assumed from the description of the embodiment.
Target a subject at the center of a depth range.
Target a detection object present in the depth range.
Target a subject (or detection object) present in the depth range and in an in-plane range.
Target the closest subject (or detection object) in the depth range.
Target the farthest subject (or detection object) in the depth range.
Target the subject (or detection object) closest to the focus position of the MF state at that time in the depth range.

While various examples other than these are conceivable, by determining the target using the setting of the depth range, the user can perform setting to execute tracking AF according to the distance of the subject.

If a subject or a detection object closest to the imaging device 1 is targeted, it is possible to make it difficult for the target to be lost (become untrackable) in the process of tracking AF.

In the first, second, fourth, and fifth embodiments, an example has been described in which the camera control unit 16 determines a target of tracking AF processing on the basis of detection of depth information (defocus information or distance information) for a subject.

The following example is assumed from the description of the embodiment when a target of the tracking AF is determined on the basis of the defocus information or the distance information.
Target the closest subject (or detection object).
Target the farthest subject (or detection object).
Target the detection object closest to the focus position of the MF state at that time.
Target the subject closest to the focus position of the MF state at that time.

While various examples other than these are conceivable, by determining the target using the defocus information or the distance information, the user can perform setting to execute tracking AF according to the distance of the subject.

In the first, second, third, and fifth embodiments, an example has been described in which the camera control unit 16 determines the target of tracking AF processing on the basis of the object detection processing for the captured image.

The target of the tracking AF is determined according to the detection object obtained by the object detection processing on the captured image. The following examples are assumed from the description of the embodiment.
Target a detection object.
Target a subject that is a detection object and is in a set in-plane range.
Target a subject that is a detection object and is in a set depth range.
Target a subject that is a detection object and is in a set in-plane range and is in a set depth range.

While various examples other than these are conceivable, by determining the target on the basis of the object detection processing, the tracking AF can be started for the object detected in the image.

In the first, second, third, and fifth embodiments, an example has been described in which the camera control unit 16 sets a detection object selected from among a plurality of detection objects as a target of tracking AF processing in a case where there is a plurality of detection objects obtained by object detection processing on a captured image.

In a case where a plurality of detection objects is obtained by object detection processing on a captured image, the following examples are assumed from the description of the embodiment.
Target a detection object of a maximum size or a detection object of a minimum size.
Target the closest detection object.
Target the farthest detection object.
Target a detection object having a high priority.
Target the detection object closest to the focus position of the MF state at that time.
In a case where one of the detection objects is in the in-plane range and the other is not, target the one in the in-plane range.
In a case where one of the detection objects is in the depth range and the other is not, target the one in the depth range.
Among the detection objects, in a case where one is in the in-plane range and the depth range and the other is not, target the one in the in-plane range and the depth range.
Among the plurality of detection objects in the in-plane range, target a detection object selected under conditions such as a size, a distance to the imaging device, a distance to the focus position, an in-plane position, and a priority order.
Among the plurality of detection objects in the depth range, target a detection object selected under conditions such as a size, a distance to the imaging device, a distance to the focus position, an in-plane position, and a priority order.
Among the plurality of detection objects in an in-plane range and in a depth range, target a detection object selected under conditions such as a size, a distance to the imaging device, a distance to the focus position, an in-plane position, and a priority order.

While various examples other than these are conceivable, by targeting the one selected in the detection processing, the target of the tracking AF can be appropriately set even in a case where there is a plurality of detection objects in the image.

In the first, second, third, fourth, and fifth embodiments, an example has been described in which the camera control unit 16 determines a target of tracking AF processing on the basis of a focus position in the MF state.

The target of tracking AF is determined when tracking AF is started by a trigger, that is, using the focus position set by the operation in the immediately preceding MF state. The following examples are assumed from the description of the embodiment.
Target a subject (or detection object) whose distance is the focus position.
Target a detection object whose distance is close to the focus position.
Target the subject (or detection object) closest to the focus position in the in-plane range.
Target a subject (or detection object) closest to the focus position in the depth range.
Target the subject (or detection object) closest to the focus position in the in-plane range and in the depth range.

While various examples other than these are conceivable, by determining the target on the basis of the focus position in the MF state, the user can set the subject distance at which the tracking AF is started by the immediately preceding MF operation.

Note that in the embodiment, the focus position detection processing according to the focus operation is performed in step S100 in FIGS. 5, 10, 13, 16, and 19. This is necessary in a case where the distance (absolute value) from the imaging device 1 is used as the depth information.

On the other hand, the depth range and the depth information can be set on the basis of defocus (relative value) or used for target determination. In that case, the processing of step S100 is not essential. For example, there is an example in which step S100 is not performed in a case of adopting a method of targeting a subject or a detection object close to the focus position.

The program of the embodiment is, for example, a program for causing a processor such as a CPU or a DSP, or a device including the processor to execute the processing of any of FIG. 5, 10, 13, 16, or 19 described above.

That is, the program according to the embodiment is a program for causing the imaging device 1 (processor mounted in the imaging device 1) to execute focus control processing of performing trigger detection in an MF state in which focus lens driving based on manual operation is performed and starting tracking AF processing on the basis of the detection of the trigger.

With such a program, it is possible to provide the imaging device 1 capable of activating smooth tracking AF from the MF state.

Such a program may be recorded in advance in an HDD as a recording medium built in a device such as a computer device, a ROM in a microcomputer having a CPU, or the like. Furthermore, such a program may be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, a memory card, or the like. Such a removable recording medium may be provided as what is called package software.

Furthermore, such a program can be installed from the removable recording medium into a personal computer or the like, or can be downloaded from a download site via a network such as a local area network (LAN) or the Internet.

Furthermore, such a program is suitable for providing the imaging device 1 of the embodiment in a wide range. For example, not only a camera as a dedicated device that captures a moving image or a still image, but also a device having an imaging function, such as a personal computer, a mobile terminal device such as a smartphone or a tablet, a mobile phone, or a game device, can be caused to function as the imaging device 1 of the present disclosure.

Note that the effects described in the present specification are merely examples and are not limited, and there may be other effects.

Note that the present technology can also have the following configurations.

(1)

An imaging device including
a control unit that performs trigger detection including processing of detecting a trigger in a manual focus state in which focus lens driving based on a manual operation is performed, and starts tracking autofocus processing on the basis of a result of the trigger detection.
   (2)

The imaging device according to (1), in which
the trigger includes a user operation of designating a position in a screen displaying a captured image.
   (3)

The imaging device according to (1) or (2), in which
the trigger includes an operation of a specific operation element by a user.
   (4)

The imaging device according to any one of (1) to (3), in which
the trigger is generated on the basis of object detection processing on a captured image.
   (5)

The imaging device according to any one of (1) to (4), in which
the trigger is generated on the basis of sensing information.
   (6)

The imaging device according to (5), in which
the sensing information includes depth information for a subject.
   (7)

The imaging device according to any one of (1) to (6), in which
the trigger is generated on the basis of setting of an in-plane range as an area in an image plane of a captured image.
   (8)

The imaging device according to (7), in which
the control unit performs presentation control of the in-plane range.
   (9)

The imaging device according to any one of (1) to (8), in which
the trigger is generated on the basis of setting of a depth range including a range of a distance to a subject.
   (10)

The imaging device according to (9), in which
the control unit performs presentation control of the depth range.
   (11)

The imaging device according to any one of (1) to (10), in which
the control unit determines a target of tracking autofocus processing on the basis of a designated position in a plane of a captured image designated by an operation.
   (12)

The imaging device according to any one of (1) to (10), in which
the control unit determines a target of tracking autofocus processing on the basis of an in-plane range set as an area in an image plane of a captured image.
   (13)

The imaging device according to any one of (1) to (10), in which
the control unit determines a target of tracking autofocus processing on the basis of setting of a depth range including a range of a distance to a subject.
   (14)

The imaging device according to any one of (1) to (13), in which
the control unit determines a target of tracking autofocus processing on the basis of detection of depth information for a subject.
   (15)

The imaging device according to any one of (1) to (14), in which
the control unit determines a target of tracking autofocus processing on the basis of object detection processing on a captured image.
   (16)

The imaging device according to (15), in which
in a case where there is a plurality of detection objects obtained by object detection processing on a captured image, the control unit sets a detection object selected from the plurality of detection objects as a target of tracking autofocus processing.
   (17)

The imaging device according to any one of (1) to (10) and (12) to (16), in which
the control unit determines a target of tracking autofocus processing on the basis of a focus position in a manual focus state.
   (18)

A method of controlling an imaging device, the method including
performing, by the imaging device, trigger detection including processing of detecting a trigger in a manual focus state in which focus lens driving based on a manual operation is performed, and starting tracking autofocus processing on the basis of a result of the trigger detection.
   (19)

A program for causing an imaging device to execute focus control processing including performing trigger detection that includes processing of detecting a trigger in a manual focus state in which focus lens driving based on a manual operation is performed, and starting tracking autofocus processing on the basis of a result of the trigger detection.

### REFERENCE SIGNS LIST

1 Imaging device
4 Rear monitor
6 Operation element
6C1, 6C2, 6C3, 6C4, 605, 6C6 Custom key
7 Focus ring
16 Camera control unit
30 Focus control unit
31 UI control unit
32 Focus position detection unit
33 Depth information detection unit
34 Range setting unit
35 Object detection unit

1. An imaging device comprising
a control unit that performs trigger detection including processing of detecting a trigger in a manual focus state in which focus lens driving based on a manual operation is performed, and starts tracking autofocus processing on a basis of a result of the trigger detection.

2. The imaging device according to claim 1, wherein
the trigger includes a user operation of designating a position in a screen displaying a captured image.

3. The imaging device according to claim 1, wherein
the trigger includes an operation of a specific operation element by a user.

4. The imaging device according to claim 1, wherein
the trigger is generated on a basis of object detection processing on a captured image.

5. The imaging device according to claim 1, wherein
the trigger is generated on a basis of sensing information.

6. The imaging device according to claim 5, wherein
the sensing information includes depth information for a subject.

7. The imaging device according to claim 1, wherein
the trigger is generated on a basis of setting of an in-plane range as an area in an image plane of a captured image.

8. The imaging device according to claim 7, wherein
the control unit performs presentation control of the in-plane range.

9. The imaging device according to claim 1, wherein
the trigger is generated on a basis of setting of a depth range including a range of a distance to a subject.

10. The imaging device according to claim 9, wherein
the control unit performs presentation control of the depth range.

11. The imaging device according to claim 1, wherein
the control unit determines a target of tracking autofocus processing on a basis of a designated position in a plane of a captured image designated by an operation.

12. The imaging device according to claim 1, wherein
the control unit determines a target of tracking autofocus processing on a basis of an in-plane range set as an area in an image plane of a captured image.

13. The imaging device according to claim 1, wherein
the control unit determines a target of tracking autofocus processing on a basis of setting of a depth range including a range of a distance to a subject.

14. The imaging device according to claim 1, wherein
the control unit determines a target of tracking autofocus processing on a basis of detection of depth information for a subject.

15. The imaging device according to claim 1, wherein
the control unit determines a target of tracking autofocus processing on a basis of object detection processing on a captured image.

16. The imaging device according to claim 15, wherein
in a case where there is a plurality of detection objects obtained by object detection processing on a captured image, the control unit sets a detection object selected from the plurality of detection objects as a target of tracking autofocus processing.

17. The imaging device according to claim 1, wherein
the control unit determines a target of tracking autofocus processing on a basis of a focus position in a manual focus state.

18. A method of controlling an imaging device, the method comprising
performing, by the imaging device, trigger detection including processing of detecting a trigger in a manual focus state in which focus lens driving based on a manual operation is performed, and starting tracking autofocus processing on a basis of a result of the trigger detection.

19. A program for causing an imaging device to execute focus control processing including performing trigger detection that includes processing of detecting a trigger in a manual focus state in which focus lens driving based on a manual operation is performed, and starting tracking autofocus processing on a basis of a result of the trigger detection.
